(19) United States
(12) Patent Application Publication
(10) Pub. No.: US 2025/0030240 A1
(43) Pub. Date: Jan. 23, 2025

(54) DYNAMIC FRAMEWORK FOR MANAGING AN INTEGRATED ENERGY SYSTEM AND METHODS THEREOF

(71) Applicants: Duke University, Durham, NC (US); The Trustees of Dartmouth College, Hanover, NH (US)

(72) Inventors: David B. Brown, Durham, NC (US); James E. Smith, Hanover, NH (US)

(21) Appl. No.: 18/776,887

(22) Filed: Jul. 18, 2024

Related U.S. Application Data
(60) Provisional application No. 63/527,676, filed on Jul. 19, 2023.

(51) Int. Cl. H02J 3/00

(52) U.S. Cl. CPC H02J 3/0075; H02J 3/003; H02J 2203/10; H02J 2203/20

(57) ABSTRACT

A method for dynamically managing an energy system includes determining a production plan by determining a first stochastic system dynamic program (SSDP) based on a state of and a forecasted energy demand in the energy system, determining a second SSDP by relaxing the first SSDP, decomposing the second SSDP into energy unit-specific SSDPs, applying the unit-specific SSDPs with a price model to define a bound on the first SSDP, and determining a forward-looking dynamic economic dispatch plan based on the second SSDP by identifying actions for the energy units corresponding to reachable production levels, applying current unit-specific states and the identified actions to the production plan to generate an updated production plan including unit-specific actions and expected continuation values based on the second SSDP that modify subsequent actions, and dispatching the identified unit-specific actions to the energy system.

### CROSS-REFERENCE TO RELATED APPLICATION

This application claims the benefit of, and priority to, U.S. Provisional Patent Application No. 63/527,676, filed on Jul. 19, 2023, the entire content of which is hereby incorporated by reference herein.

### GOVERNMENT LICENSE RIGHTS

This invention was made with government support under Federal Grant No. DE AR001283, awarded by the U.S. Department of Energy. The government has certain rights in the invention.

### BACKGROUND

### Technical Field

The present disclosure relates to the field of managing energy generation systems, and in particular, managing a plurality of energy generations systems having differing means of generating energy.

### Description of Related Art

Renewable energy sources like solar and wind are prone to variability and uncertainty. Although variable and uncertain demand has always been an issue for energy systems, the growing reliance on renewable energy increases the need for energy system operators to manage production system carefully. This challenge is particularly complex in systems which consist of vertically integrated utilities which may consist of many generation and storage units with different characteristics and efficiencies. To address these issues, energy system operators solve unit commitment optimization problems to implement production plans for the myriad generation and storage units within the energy system. While these formulations are complex, they do not model uncertainty when formulating production plans.

### SUMMARY

A method for dynamically managing an energy system includes determining a production plan for the energy system over a finite time horizon, the energy system including a plurality of energy units, wherein determining the production plan includes determining a first stochastic system dynamic program based on a state of the energy system and an energy demand in the energy system, the energy demand corresponding to a baseline forecast model, wherein the first stochastic system dynamic program is subject to a constraint of meeting the energy demand of the baseline forecast model over discrete time periods of the finite time horizon and a corresponding state of the energy system, determining a second stochastic system dynamic program by relaxing the first stochastic system dynamic program, wherein relaxing the first stochastic system dynamic program includes applying stochastic value functions based on a history of states of the energy system, decomposing the second stochastic system dynamic program into unit-specific stochastic system dynamic programs corresponding to each energy unit of the plurality of energy units, and applying the unit-specific stochastic system dynamic programs with a price model to define a bound on the first stochastic system dynamic program, wherein the price model is based on the state of the energy system, and determining a forward-looking dynamic economic dispatch plan using the second stochastic system dynamic program for each discrete time period of the finite time horizon, wherein determining the economic dispatch plan for each discrete time period includes identifying a current state for the energy system corresponding to a first discrete time period of the finite time horizon, identifying current unit-specific states corresponding to the first discrete time period, wherein the current unit-specific states are identified from the identified current state of the energy system, identifying actions for each energy unit corresponding to production levels that are reachable from the identified current unit-specific states, applying the current unit-specific states and the identified actions to the production plan to generate an updated production plan, the updated production plan including unit-specific actions and unit-specific expected continuation values based on the second stochastic system dynamic system that modify subsequent actions over the finite time horizon, and dispatching the identified unit-specific actions to the energy system.

In aspects, identifying the current state corresponding to the first discrete time period may include identifying a current energy demand state corresponding to the first discrete time period.

In other aspects, applying the current unit-specific states may include meeting the identified current energy demand state.

In certain aspects, determining the forward-looking dynamic economic dispatch plan may include applying a mixed integer linear program to the updated production plan to identify the unit specific actions that satisfy a current energy demand of the current state of the energy system.

In other aspects, determining the first stochastic system dynamic program may include determining the first stochastic system dynamic program based on the current state of the energy system, the current energy demand in the energy system, and forecasts of energy demands in the energy system.

In aspects, determining the first stochastic system dynamic program may include subjecting the first stochastic system dynamic program to the constraints of meeting the current energy demands over the discrete time periods of the finite time horizon and the current state and the forecasted energy demands in the energy system.

In certain aspects, applying the unit-specific stochastic system dynamic programs to the price model may include applying the unit-specific stochastic system dynamic programs with a parameterized price model to define a bound on the first stochastic system dynamic program.

In other aspects, determining the production plan for the energy system may include identifying price model parameters, wherein the identified price model parameters, when applied to the unit-specific stochastic system dynamic programs, define an optimized bound on the first stochastic system dynamic program.

In accordance with another aspect of the disclosure, a computing device for dynamically managing an energy system includes a processor, and a memory operably coupled to the processor, the memory storing instructions, which when executed by the processor cause the processor to determine a production plan for an energy system over a finite time horizon, the energy system including a plurality of energy units, wherein determining the production plan includes determining a first stochastic system dynamic program based on a state of the energy system and an energy demand in the energy system, the energy demand corresponding to a baseline forecast model, wherein the first stochastic system dynamic program is subject to a constraint of meeting the energy demand of the baseline forecast model over discrete time periods of the finite time horizon and a corresponding state of the energy system, determining a second stochastic system dynamic program by relaxing the first stochastic system dynamic program, wherein relaxing the first stochastic system dynamic program includes applying stochastic value functions based on a history of states of the energy system, decomposing the second stochastic system dynamic program into unit-specific stochastic system dynamic programs corresponding to each energy unit of the plurality of energy units, and applying the unit-specific stochastic system dynamic programs with a price model to define a bound on the first stochastic system dynamic program, wherein the price model is based on the state of the energy system, and determine a forward-looking dynamic economic dispatch plan based on the second stochastic system dynamic program for each discrete time period of the finite time horizon, wherein determining the economic dispatch plan for each discrete time period includes identifying a current state for the energy system corresponding to a first discrete time period of the finite time horizon, identifying current unit-specific states corresponding to the first discrete time period, wherein the current unit-specific states are identified from the identified current state of the energy system, identifying actions for each energy unit corresponding to production levels that are reachable from the identified current unit-specific states, applying the current unit-specific states and the identified actions to the production plan to generate an updated production plan, the updated production plan including unit-specific actions and unit-specific expected continuation values based on the second stochastic system dynamic program that modify subsequent actions over the finite time horizon, and dispatching the identified unit-specific actions to the energy system.

In certain aspects, the memory may store thereon further instructions, which when executed, cause the processor to determine the first stochastic system dynamic program based on the current energy demand state corresponding to the first discrete time period.

In aspects, the memory may store thereon further instructions, which when executed, cause the processor to determine the forward looking dynamic economic dispatch plan by applying unit-specific states that meet the identified current energy demand state.

In other aspects, the memory may store thereon further instructions, which when executed, cause the processor to apply the unit-specific stochastic system dynamic programs with a parameterized price model to define a bound on the first stochastic system dynamic program.

In aspects, the memory may store thereon further instructions, which when executed, cause the processor to identify price model parameters, wherein the identified price model parameters, when applied to the unit-specific stochastic system dynamic programs, define an optimized bound on the first stochastic system dynamic program.

In certain aspects, the memory may store thereon further instructions, which when executed, cause the processor to determine the forward-looking dynamic economic dispatch plan by applying a mixed integer linear program to the updated production plan to identify the unit specific actions that satisfy a current energy demand of the current state of the energy system.

In accordance with another aspect of the disclosure, a non-transitory computer-readable storage medium storing instructions, which when executed by a processor, causes the processor to determine a production plan for an energy system over a finite time horizon, the energy system including a plurality of energy units, wherein determining the production plan includes determining a first stochastic system dynamic program based on a state of the energy system and an energy demand in the energy system, the energy demand corresponding to a baseline forecast model, wherein the first stochastic system dynamic program is subject to a constraint of meeting the energy demand of the baseline forecast model over discrete time periods of the finite time horizon and a corresponding state of the energy system, determining a second stochastic system dynamic program by relaxing the first stochastic system dynamic program, wherein relaxing the first stochastic system dynamic program includes applying stochastic value functions based on a history of states of the energy system, decomposing the second stochastic system dynamic program into unit-specific stochastic system dynamic programs corresponding to each energy unit of the plurality of energy units, and applying the unit-specific stochastic system dynamic programs with a price model to define a bound on the first stochastic system dynamic program, wherein the price model is based on the state of the energy system, and determine a forward-looking dynamic economic dispatch plan based on the second stochastic system dynamic program for each discrete time period of the finite time horizon, wherein determining the economic dispatch plan for each discrete time period includes identifying a current state for the energy system corresponding to a first discrete time period of the finite time horizon, identifying current unit-specific states corresponding to the first discrete time period, wherein the current unit-specific states are identified from the identified current state of the energy system, identifying actions for each energy unit corresponding to production levels that are reachable from the identified current unit-specific states, applying the current unit-specific states and the identified actions to the production plan to generate an updated production plan, the updated production plan including unit-specific actions and unit-specific expected continuation values based on the second stochastic system dynamic program that modify subsequent actions over the finite time horizon, and dispatching the identified unit-specific actions to the energy system.

In aspects, the instructions, when executed by the processor, may cause the energy system to apply the unit-specific stochastic system dynamic programs with a parameterized price model to define a bound on the first stochastic system dynamic program.

In certain aspects, the instructions, when executed by the processor, may cause the energy system to identify price model parameters, wherein the identified price model parameters, when applied to the unit-specific stochastic system dynamic programs, define an optimized bound on the first stochastic system dynamic program.

In other aspects, the instructions, when executed by the processor, may cause the energy system to identify a current energy demand state corresponding to the first discrete time period.

In aspects, the instructions, when executed by the processor, may cause the energy system to apply the current unit-specific states to meet the identified current energy demand state.

In other aspects, the instructions, when executed by the processor, may cause the energy system to determine the forward-looking economic dispatch plan by applying a mixed integer linear program to the updated production plan to identify the unit specific actions that satisfy a current energy demand of the current state of the energy system.

### BRIEF DESCRIPTION OF THE DRAWINGS

The patent or application file contains at least one drawing executed in color. Copies of this patent or patent application publication with color drawing(s) will be provided by the Office upon request and a payment of the necessary fee.

Various aspects and embodiments of the disclosure are described hereinbelow with references to the drawings, wherein:

FIG. 1 is a topographical view of an energy system in accordance with the disclosure;

FIG. 2 is a schematic view of a computing device of the energy system of FIG. 1;

FIG. 3 is a graphical representation of a historical daily net load on the energy system of FIG. 1;

FIG. 4 is a graphical representation of a production cost vs. cumulative production capacity of the energy system of FIG. 1;

FIG. 5 is a graphical representation of a forecasted net demand on the energy system of FIG. 1 over time;

FIG. 6 is a graphical representation of a unit commitment plan based on the forecasted net demand of FIG. 5;

FIG. 7 is a graphical representation of power production over time for the energy system of FIG. 1 during a high demand scenario using the unit commitment model;

FIG. 8 is a graphical representation of power production over time for the energy system of FIG. 1 during a low demand scenario using the unit commitment model;

FIG. 9 is a graphical representation of an embodiment of a price model for the energy system of FIG. 1, illustrating the use of period-specific constants;

FIG. 10 is a graphical representation of another embodiment of a price model for the energy system of FIG. 1, illustrating the use of period-specific linear functions;

FIG. 11 is a graphical representation of yet another embodiment of a price model for the energy system of FIG. 1, illustrating the use of a simple model with tailored basis functions;

FIG. 12 is a graphical representation of a unit specific value function vs. unit production for generators of the energy system of FIG. 1;

FIG. 13 is a graphical representation of a unit specific value function vs. unit production for storage units of the energy system of FIG. 1;

FIG. 14 is a graphical representation of power production over time for the energy system of FIG. 1 during a high demand scenario using the methods described herein and the simple price model of FIG. 11;

FIG. 15 is a graphical representation of power production over time for the energy system of FIG. 1 during a low demand scenario using the methods described herein and the simple price model of FIG. 11;

FIG. 16A is a flow diagram of a method for managing the energy system of FIG. 1; and

FIG. 16B is a continuation of the flow diagram of FIG. 1A.

### DETAILED DESCRIPTION

The present disclosure is directed to systems, methods, and apparatus for dynamically managing an energy system. The dynamic programming approach to managing an energy system helps system operators manage production under uncertainty. In this manner, energy demand and renewable supply (and potential other uncertainties), the world state, may be modeled as an exogenous discrete-time stochastic process over a fixed horizon, such as a day or a week. Periods in the model may correspond to hours, and dispatch decisions are made in each period. As can be appreciated, the energy system may include many generation units, each with different characteristics, as well as storage units. Although the system-level stochastic dynamic program (DP) may be complex, the DP may be decomposed using a Lagrangian relaxation, although it is contemplated that any relaxation may be employed. In this manner, constraints that demand and production must balance in each period and each scenario may be relaxed by imposing Lagrange multipliers that punish violations of these constraints. These Lagrange multipliers are, in general, stochastic, depending on the history of world states, and can be interpreted as prices that units are paid for the energy produced. The resulting relaxed model decouples across units into a set of unit-specific DPs where each unit maximizes its own profit, keeping track of its own state and the stochastic world state.

Various functional forms for the stochastic price models may be considered in this Lagrangian relaxation, and for any price model, the relaxed model provides an upper bound on the system's total profit (or a lower bound on the total costs) and the best such bound for a particular price model may be found by solving the dual optimization problem. As can be appreciated, the optimal Lagrange multipliers (or prices) ensure that the production in the relaxed model matches certain statistical features of the demand process. For example, with a fully general stochastic price process, the optimality conditions ensure that production in the Lagrangian model matches demand in every scenario, albeit with mixed policies. In this case, a bound on the gap between the Lagrangian and the value function that is independent of the number of units in the system and the number of world states in the model may be provided. In this manner, considering period-specific deterministic prices, optimality conditions ensure production in the Lagrangian model matches demand in expectation in each period.

It is envisioned that the decomposed Lagrangian DP may serve a role analogous to that of a deterministic unit commitment (UC) problem, where the relaxed DP model provides a plan for operating the system on a given day. In embodiments, the plans are state-contingent, describing what each unit should do in each world state. To ensure that these unit-specific state-contingent plans are consistent and meet the actual demand in each period, a forward-looking version of an economic dispatch (ED) problem may be solved. In this manner, in each period, a mixed integer linear program is solved that maximizes the sum of unit-specific values, using unit-specific DP value functions from the Lagrangian relaxation), subject to the constraint of matching demand exactly and respecting all other system constraints. As can be appreciated, these unit-specific value functions embed long-term considerations when making hourly dispatch decisions.

In is envisioned that in this forward-looking ED problem the operator has full flexibility to control any and all plants, as well as storage, e.g., it operates without commitment. The ramping constraints of slow-starting units, as well as other units, are fully respected in this model, but in contrast to a deterministic UC problem, in this dynamic approach, it may be assumed that there are no exogenous constraints on the ED problem imposed by the solution of the UC problem. In this manner, the system operator may start up or shut down slow-start units, as well as fast-start units, and deploy storage as needed.

These and other aspects of the disclosure will be described in further detail hereinbelow. Although generally described with reference to power generation system, it is contemplated that the systems and methods described herein may be used with any system having multiple units or devices without departing from the scope of the disclosure.

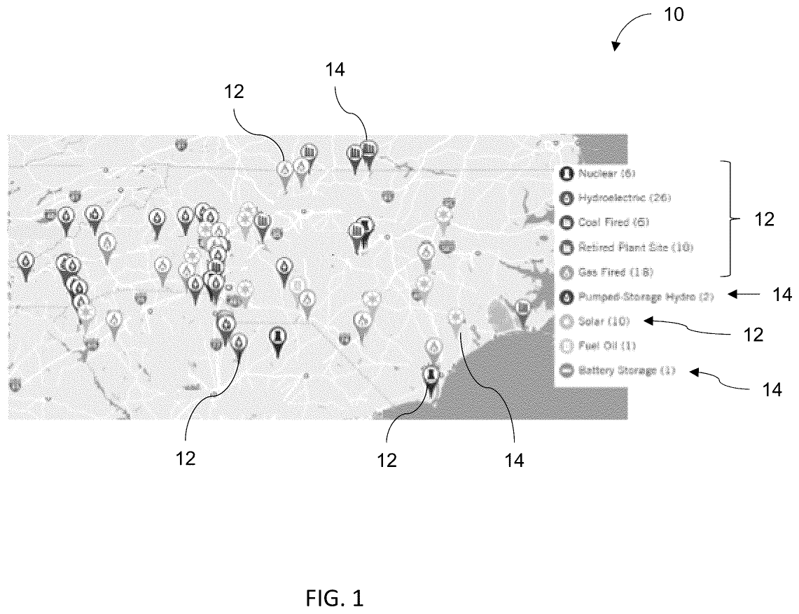

Turning now to the drawings, FIG. 1 illustrates an energy system 10 in accordance with the disclosure having generation units 12 and storage units 14. Although generally described herein as being a vertically integrated energy system, it is envisioned that the energy system 10 may be managed by independent system operators (ISOs), other system management modalities, or combinations of vertically integrated systems, ISOs, or other system management modalities without departing from the scope of the disclosure.

It is envisioned that the energy system 10 may include any number of generation units 12 and any number of storage units 14, and in embodiments, the energy system may not include any storage units 14. The generation units 12 and storage units 14 are located at various locations across a region or geographical area and operably coupled to an electrical grid (not shown) or other suitable electrical distribution system. The generation units 12 may be any suitable power generation unit, such as for example, nuclear power plants, hydroelectric power plants, coal fired power plants, gas fired power plants, and solar power plants. The storage units 14 may be any suitable energy storage device, such as for example, pumped-storage hydropower, batteries, supercapacitors, flywheels, and combinations thereof. The generation units 12 and the storage units 14 provide a maximum energy production capacity, which is the sum of the maximum energy that can be provided by the generation units 12 and the maximum energy that can be provided by the storage units 14. In one non-limiting embodiment, the energy system 10 includes a maximum energy production capacity of about 43 GW, of which about 41 GW is provided by the generation units 12 and about 2 GW is provided by the storage units 14. As can be appreciated, each type of generation unit 12 and/or storage unit 14 embodies its own characteristics, such as for example, an energy production capacity, an ability to stay on or shutdown, an amount of time to startup, a cost per unit of energy provided, and an ability to provide energy during certain times of day or weather conditions. Maintenance and planned shutdowns of generation units 12 and storage units 14 further impact the maximum energy production capacity of the energy system 10.

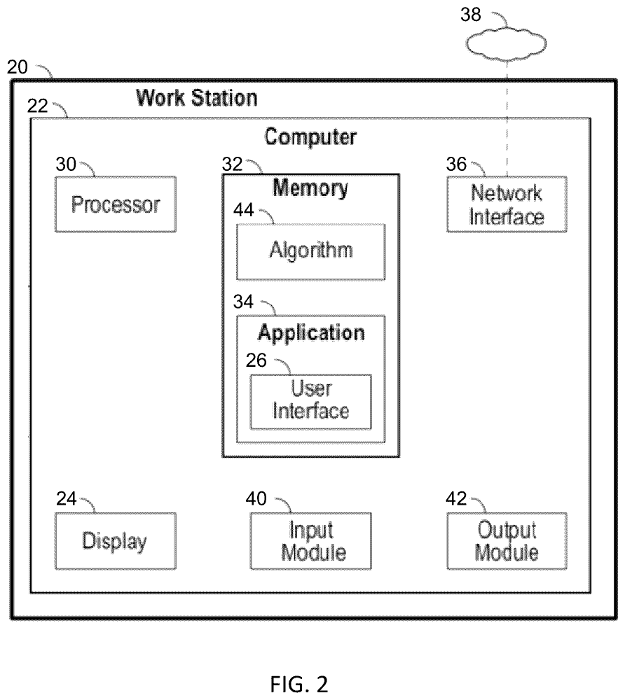

With additional reference to FIG. 2, the energy system 10 includes a workstation or computing system 20 that is operably coupled or otherwise in communication with each generation unit 12 and each storage unit 14 connected to the grid. In this manner, the computing system 20 controls the operation of each generation unit 12 and each storage unit 14 in real-time or prospectively. The computing system 20 includes a computer 22, which in embodiments, may be coupled to a display 24 that is configured to display one or more user interfaces 26. The computing system 20 may be a desktop computer or a tower configuration with the display, may be a laptop computer, may be integrated into a system control panel, etc. The computing system 20 includes a processor 30 which executes software stored in a memory 32. The memory 32 may store data or other information regarding the energy system 10, such as for example, the number and type of generation units 12, storage units 14, historical energy demands, historical energy production capabilities, and planned shutdowns or maintenance. In addition, the memory 32 may store one or more software applications 34 to be executed by the processor 30.

A network interface 36 enables the computing system 20 to communication with a variety of other devices and systems via the Internet. The network interface 36 may connect the computing system 20 to the Internet via a wired or wireless connection. Additionally, or alternatively, the communication may be via an ad-hoc Bluetooth® or wireless network enabling communication with a wide-area network (WAN) and/or a local area network (LAN). The network interface 36 may connect to the Internet via on or more gateway, routers, and network address translation (NAT) devices. The network interface 36 may communicate with a cloud storage system 38, in which further data associated with the energy system 10 may be stored. The cloud storage system 38 may be remote from or on the premises of a control room. An input module 40 receives inputs from an input device such as, for example, a keyboard, a mouse, or voice commands. An output module 42 connects the processor 30 and the memory 32 to a variety of output devices, such as, for example, the display 24. In embodiments, the computing system 20 may include its own display (not shown), which may be a touchscreen display.

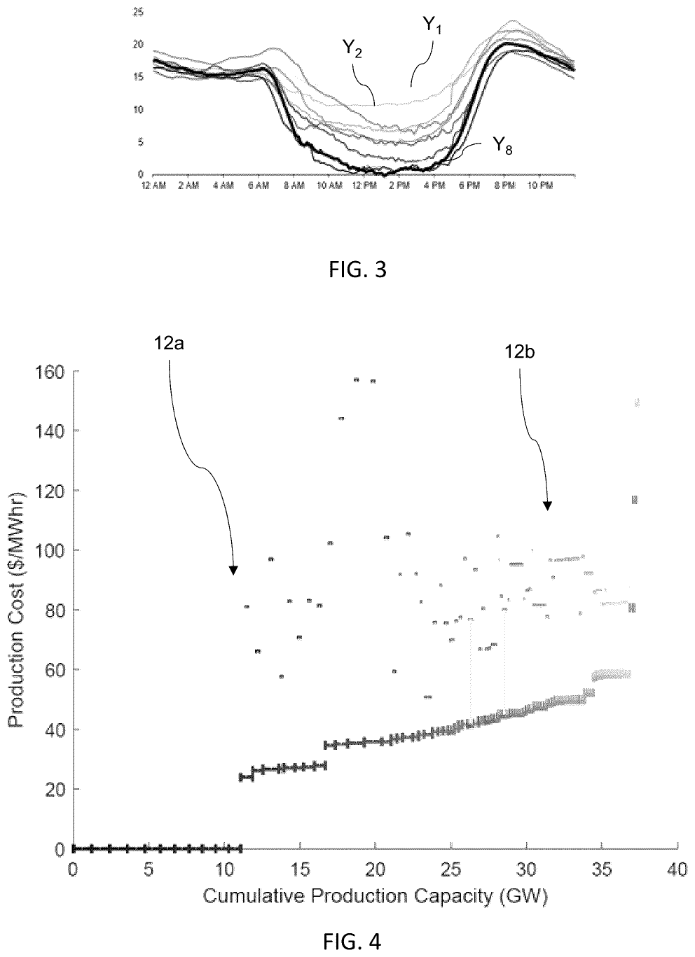

With additional reference to FIG. 3, variability and uncertainty have and continue to pose challenges for energy systems. As can be appreciated, the growing use of renewable energy, such as, for example, solar energy, wind energy, and wave energy, has exacerbated these issues. FIG. 3 illustrates a historical net energy load applied to the energy system 10 over the course of a day for multiple years Y₁ through Y₈. The upper plot Y₁ is a plot of the net energy load (e.g., for example, energy demand on the energy system 10 minus available energy from renewable energy generation units 14) applied to the energy system 10 over the course of a day for a first year and each successive plot Y₂ through Yₛ below the upper plot Y₁ is a plot of the net energy load applied to the energy system 10 over the course of day for a subsequent year. As can be appreciated, the increased reliance on solar energy requires operators of the energy system 10 to quickly ramp up energy production when the sun sets, and the amount of energy produced by solar systems falls. Comparing the upper plot Y₁ and the lower plot Yₛ demonstrates the deepening canyon or duck curve caused by the increased reliance upon renewable energy generation units 14.

Referring to FIG. 4, as described hereinabove, the memory 32 of the computing system 20 stores data and other information associated with each generation unit 12 and storage unit 14. As can be appreciated, some generation units 12, such as, for example, thermal unit, may have significant startup costs and limited ability to ramp up energy production to meet unexpected increases in energy demand on the energy system 10. Other generation units 12, such as, for example, gas turbines, may be more expensive to operate but are able to ramp up or down quickly. In certain regions of the world, unpredictable thunderstorms may pop up as the sun sets, which can suddenly reduce the production of energy by solar systems and require the operator of the energy system 10 to ramp up energy production from other sources, such as other generation units 12 or storage units 14, quickly. FIG. 4 plots a cost of producing energy ($/MWhr) compared to a cumulative energy production capacity (GW) for the energy system 10, where slow start generation units 12a are shown on the left as having low production costs whereas moving in a direction away from the y-axis, fast start generation units 12b are shown as having increasingly higher production costs. As can be appreciated, the costs associated with producing energy from each type of generation unit 12 can vary based upon fuel costs, operating costs, etc. These ever-changing variables create uncertainty when creating a production plan for the energy system 10 to meet a forecasted energy demand for a forthcoming day. It is envisioned that the demand forecasting models and/or data associated with the energy system 10, fuel costs, weather information, energy demand history, etc. can be obtained from outside sources or may be determined using the computing system 20 described herein without departing from the scope of the disclosure.

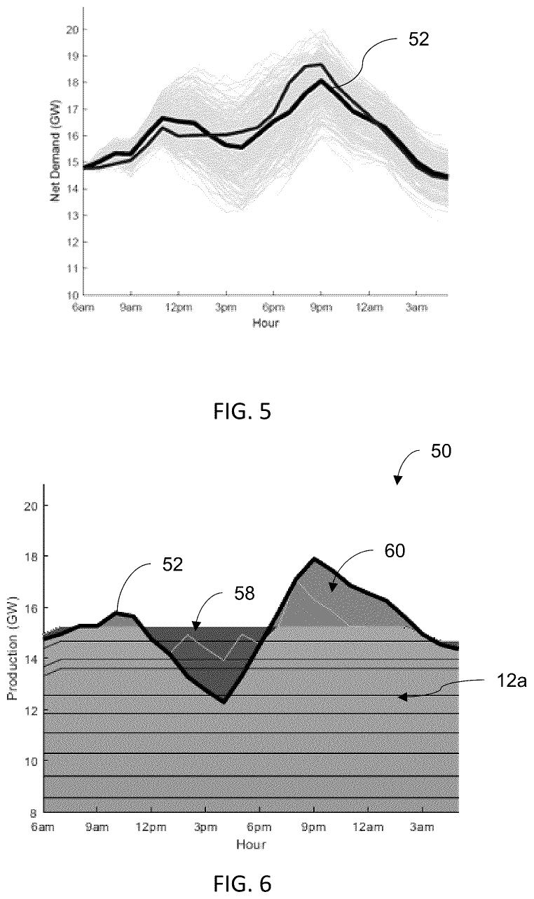

Turning to FIGS. 5-8, one embodiment of a management system for managing the energy system 10 includes solving a unit commitment (UC) problem and an economic dispatch (ED) problem. Each morning, the operator of the energy system 10 develops a unit commitment plan 50 (FIG. 6) by solving a UC problem to determine a commitment of generation units 12 to minimize operating costs of the energy system 10 while meeting the expected demand on the energy system 10 over the course of a predetermined period of time, such as, for example, a day or a week. The expected demand on the energy system 10 is plotted 52 as a net energy demand on the energy system 10 over the predetermined period of time (FIG. 5) and is generated from data stored in the memory 32, obtained over the cloud storage system 38, or via wired or wireless communication over the network interface 36. The unit commitment plan 50 identifies the type of generator unit 12 (e.g., slow start 12a or fast start 12b) and the state of storage units 14 (e.g., charging 58 or discharging 60) required to meet the expected energy demand on the energy system 10 while minimizing operating costs of the energy system 10.

Once the commitment of generation units 12 is decided, for a discrete time period, such as, for example, each hour or more frequently, the operator of the energy system 10 solves the ED problem to determine the actual power output of each generation unit 12 to meet the realized energy demand on the energy system 10 at minimum cost, subject to the commitments determined in the UC problem, as well as other constraints of the energy system 10. In embodiments, when solving the ED problem, slow-starting generation units 12a, such as, for example, thermal plants, are committed to be on or off according to the result of the UC problem, though it is envisioned that their energy production levels may be adjusted (e.g., for example, binary variables corresponding to on/off for the slow start generation units 12a in the ED problem are set to their optimal values in the UC problem). In embodiments, the flows into and out of pumped-storage hydropower are similarly committed to the UC problem. If additional energy is needed to meet the energy demands on the energy system 10, the ED problem can dispatch fast-starting generation units 12b (e.g., for example, gas turbines), subject to their physical constraints.

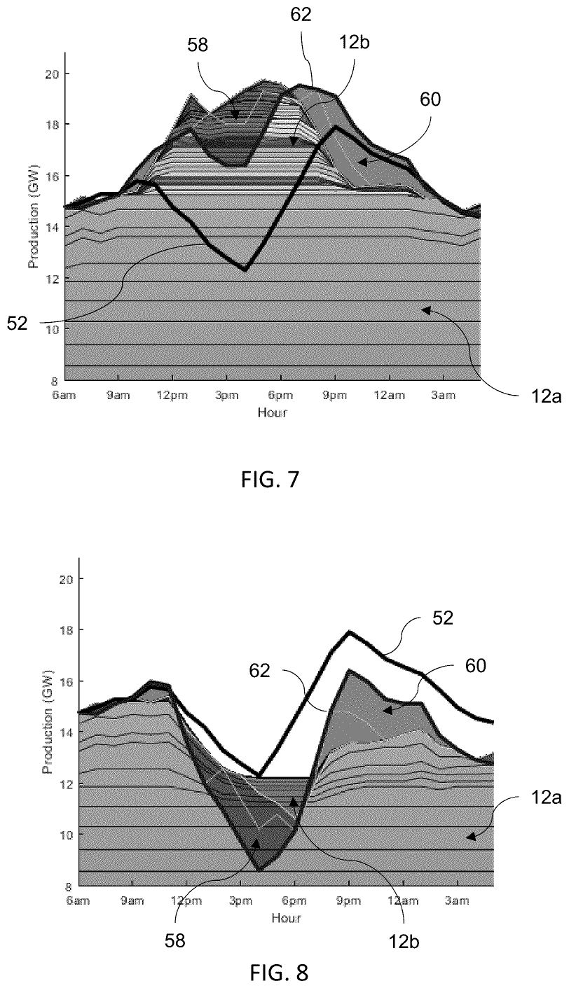

As can be appreciated, these ED problems can be myopic, focusing on minimizing the costs for a specific period, given the current state of the energy system 10. These models, while complex, do not explicitly consider uncertainty in supplies or demands for the energy system 10. For example, during a high demand scenario (FIG. 7), actual energy demand 62 on the energy system 10 exceeds the expected demand 52 at each discrete time period, causing the ED problem solved for each discrete time period to dispatch additional generation units 12 or storage units 14 to meet the actual energy demand 62. While the ED problem solved for each discrete time period dispatches additional generation units 12 and/or storage units 14 in a manner to minimize cost, many of the slow start generation units 12a and storage units 14 have already been committed, requiring the dispatch of more costly fast start generation units 12b to meet the actual energy demand 62. The dispatch of these more costly fast start generation units 54 causes an unanticipated or shadow cost 64 over the course of the time-period (e.g., the day) leading to inefficient and costly generation of energy to meet the actual energy demand 62 at each discrete time period.

In contrast, during a low demand scenario (FIG. 8), actual energy demand 62 on the energy system 10 is less than the expected demand 52 at each discrete time period, causing the ED problem solved for each discrete time period to overcommit slow start generation units 12a. Rather than shutting the slow start generation units 12a down, the ED problem solved curtails production at many of the slow start generation units 12a while continuing to incur their fixed costs. Additionally, being committed to their storage plan, the ED problem sheds a significant amount of energy supply from storage units 14 from 3 μm to 6 pm, despite the ability of this energy to be stored.

In accordance with the disclosure, uncertainty such as that described hereinabove can be taken into consideration when solving the UC problem and the ED problems to make more efficient use of the available generation units 12 and storage units 14 of the energy system 10 as compared to the myopic approach described hereinabove. In embodiments, the algorithm 44 of the computing system can solve the UC problem using a weakly coupled stochastic dynamic program (DP) to determine unit specific DP value functions with optimized prices and then solve the ED problem using a forward-looking dispatch problem using the determined unit specific DP value functions and relaxing commitments on the energy system 10. In this manner, the energy demand on the energy system 10 and the renewable energy supply (and potentially other uncertainties), e.g., a world state or state, is modeled as an exogenous discrete-time stochastic process over a fixed horizon, such as, for example, a day or a week. The discrete periods of time in the model correspond to hours, and dispatch decisions are made in each period. As can be appreciated, the modeled energy system 10 may include many generation units 12, each with different characteristics, as well as storage units 14.

Although the system-level stochastic DP may be too complex to solve exactly, the problem may be decomposed using a Lagrangian relaxation, although it is envisioned that any suitable model can be utilized to relax the system-level stochastic DP without departing from the scope of the disclosure. For example, the constraints that the energy demand and energy production must balance in each discrete period and each scenario can be relaxed by imposing Lagrange multipliers that punish violations of these constraints. These Lagrange multipliers are, in general, stochastic—depending on the history of world states—and can be interpreted as “prices” that units are paid for the energy produced. The resulting relaxed model decouples across generation units 12 and storage units 14 into a set of unit-specific DPs where each generation unit 12 and/or storage unit 14 maximizes its own profit, keeping track of its own state and the stochastic world state. In embodiments, various functional forms for the stochastic price models in the Lagrangian relaxation can be considered. For any price model, the relaxed model provides an upper bound on the energy system's 10 total profit (or a lower bound on the total costs) and the best such bound for a particular price model can be found by solving the dual optimization problem. As can be appreciated, the optimal Lagrange multipliers (or prices) ensure that the energy production of the energy system 10 in the relaxed model matches certain statistical features of the demand process. For example, with a fully general stochastic prices process, the optimality conditions ensure that energy production in the Lagrangian model matches energy demand on the energy system 10 in every scenario, albeit with mixed policies. In embodiments, a bound on the gap between the Lagrangian value function that is independent of the number of generation units 12 and/or storage units 14 of the energy system 10 and the number of states in the model. If period specific deterministic prices are considered, the optimality conditions ensure energy production in the Lagrangian model matches energy demand on the energy system 10 in expectation in each period. It is envisioned that specific models can be derived for the generation units 12 and the storage units 14 and structural properties of the unit specific DPs can be derived. As can be appreciated, these structural properties can greatly simplify the solution of the unit specific DPs and help make the decomposed Lagrangian model tractable.

It is envisioned that the decomposed Lagrangian DP can serve a role analogous to the deterministic UC problems. For example, the relaxed DP model can provide a plan for operating the energy system 10 over a given time-period. In embodiments, the operating plans described herein are state-contingent, describing what each generation unit 12 and/or storage unit 14 should do in each world state. To ensure that the unit-specific state-contingent plans are consistent and meet the actual realized energy demand in each discrete time period, a forward-looking version of the ED problem is solved in accordance with the embodiments described herein. As will be described in further detail hereinbelow, in each discrete time period, a mixed integer linear program that maximizes the sum of unit specific values (using unit-specific DP value functions from the Lagrangian relaxation) is solved subject to the constraint of matching energy demand exactly and respecting all other energy system 10 constraints. As can be appreciated, these unit-specific value functions embed long-term considerations when making dispatch decisions for each discrete time-period (e.g., for example, hourly).

Although generally described herein with the assumption that the operator of the energy system 10 has full flexibility to control any and all generation units 12 and/or storage units 14 (e.g., for example, the energy system 10 operates without commitment). Ramping constraints of slow starting generation units 12a (as well as other types of generation units 12 and/or storage units 14) are fully respected in the model described herein, and in embodiments, in this dynamic approach, it is assumed that there are no exogenous constraints on the ED problem imposed by the solution of the UC problem. In this manner, the forward-looking version of the ED problem enables the operator of the energy system 10 to start up or shut down slow-start generation units 12a (as well as fast-start generation units 12b) and deploy storage units 14 as desired.

In one non-limiting embodiment, a dynamic approach for managing the energy system 10, and in embodiments, an integrated energy system, under uncertainty is disclosed based on methods from weakly coupled stochastic dynamic programming. As can be appreciated, the algorithm 44 and methods described hereinbelow are exemplary embodiments, and the disclosure is not so limited. The algorithm 44 considers a finite horizon with periods t=1, . . . , T with power demands (d₁, . . . , d_{T}) in each period. In one non-limiting embodiment, the periods t are discrete time periods, such as, for example, one hour and the time horizon T=24 or 168 corresponding to a day or a week. The operation of the energy system 10 or decision-maker (DM) seeks to maximize the profit (or minimize costs) over this horizon T.

In embodiments, the algorithm 44 considers a general model of demands and renewable supplies, assuming they are generated by some Markov process with world-state ψₜ∈Ψ. The algorithm 44 assumes that the world state includes the current demand dₜ and supplies for weather-dependent units and everything needed to generate forecasts for future energy demands on the energy system 10 and supplies for weather-dependent generation units 12 and/or storage units 14. This world-state ψₜ could, in principle, be a large and complex state variable noting current temperatures and forecasts of future temperatures (as well as other weather variables), generation unit 12 outages, and fuel costs, as well as the current energy demand on the energy system 10 and weather-related supplies. It may be assumed that the world-state transitions are exogenous (independent of the energy system 10 state and DM's actions) and that the period-t world-state ψₜ is known to the DM when making decisions in period t. In embodiments, [symbol] =(F₁, . . . , F_{T}) denotes the filtration representing the DM's knowledge of the world-state over time. In one non-limiting embodiment, to avoid measurability and related technical issues, the algorithm 44 may assume that the world-state space Ψ is finite.

In the energy system 10, there are S generation units 12 of various types having corresponding characteristics and details. The state of a unit s (of the generation units 12 and storage units 14) in any given period is summarized by a state variable xₛ ∈Xₛ. In each period, the DM may select an action as from a feasible set Aₛ(xₛ, ψₜ)⊆Aₛ, where Aₛ denotes the action space. These actions produce pₛ(aₛ) units of energy and cost cₛ(xₛ, as, ψₜ). The state of the unit s then evolves deterministically to Xₛ(xₛ, aₛ, ψₜ) in the next period. The constraint sets may depend on the world-state ψₜ, reflecting the availability of wind or solar power or a unit s or system outage. In embodiments, the costs may depend on ψₜ, reflecting, for example, fuel costs for generation units 12. The transitions may also depend on the world-state, reflecting, for example, a reservoir filling because of rainfall.

In embodiments, x=(x₁, . . . , x_{S}) denotes a vector of unit states (the system state), a=(a₁, . . . , a_{S}) a vector of control decisions (a system action), A(x, ψ)=A₁(x₁, ψ)× γ×A_{S}(x_{S}, ψ) the set of feasible system actions, p(a)=Σₛ₌₁^{S}pₛ(aₛ) the total power produced, c(x, a, ψ)=Σₛ₌₁^{S}cₛ(xₛ, aₛ, ψ) the total cost, and Xₜ(x, a, ψ)=(X₁,t(x₁, a₁, ψ), . . . , X_{S},t(x_{S}, a_{S}, ψ)) the corresponding vector of next-period unit states.

The DM may choose actions in each period t with the goal of maximizing the expected total reward (or minimizing total costs) over the time horizon, subject to the constraint of meeting demand in each period t and in each state. As can be appreciated, for ease of later interpretation, the rewards are maximized rather than minimizing costs. In embodiments, the problem may be formulated as a DP. Taking the terminal value V_{T+1}*(x, ψ_{T+1})=0, the optimal value function for earlier periods may be written as:

$$\\ \begin{matrix}{V}_{t}^{{}_{} *} ( x , {ψ}_{t} ) = {max}_{a ∈ A ( x , {ψ}_{t} )} - c ( x , a , {ψ}_{t} ) + 𝔼 [ {V}_{t + 1}^{{}_{} *} ( {X}_{t} ( x , a , {ψ}_{t} ) , {\tilde{ψ}}_{t + 1} ) \vert {ψ}_{t} ] . & Equation 1\end{matrix}$$

$$\\ s . t . p ( a ) = {d}_{t} ( {ψ}_{t} )$$

dₜ(ψₜ) is the demand in period t given world state ψₜ and [symbol] [−|ψₜ] denotes the expectation over the next-period world-state \tilde{ψ}ₜ₊₁, conditioned on the current world-state ψₜ. It is envisioned that there is a feasible solution to this DP; which may be ensured by assuming the existence of units s that can shed excess demand or supply at a cost. In embodiments, it may be assumed that the optimal value in any given state will be obtained by some vector of actions a. In one non-limiting embodiment, this formulation assumes that there are no network constraints in the system. As can be appreciated, the assumption that V_{T+1}*(x,ψ_{T+1})=0 is not critical. The Lagrangian decomposes across units s if the terminal value function is additively separable across units. For structural properties of the unit value functions to hold, the terminal value functions must also satisfy these structural properties. In embodiments, terminal value functions that are Lagrangian value functions are used for a model with a longer time horizon that has zero terminal values. As can be appreciated, these terminal value functions thus decompose and have the desired structure.

The total costs and power produced in the energy system 10 are sums of the costs and production of individual generation units 12 or storage units 14, but the optimization problem (equation 1) is complicated by the constraint that requires total production to equal demand in every period t and every state. As can be appreciated, these constraints link decisions and actions across units s. In embodiments, the model is a Lagrangian model that relaxes these linking constraints by introducing stochastic Lagrange multipliers or “prices” associated with these constraints.

In one non-limiting embodiment of the Lagrangian relaxation, the linking constraints are dualized in equation 1 that requires production to match demand by introducing Lagrange multipliers λ=(λ₁, . . . , λ_{T}) for these constraints. The period-t Lagrange multiplier λₜ may be any function that is measurable with respect to F_{T}, i.e., λₜ: Ψ^{t}→ [symbol] ¹. The Lagrange multiplier process λ is thus adapted to the filtration [symbol] and λ: Ψ¹× . . . ×Ψ^{t}→ [symbol] ^{T}. In embodiments, ηₜ=(ψ₀, . . . , ψₜ) denotes the history of world-states up to period t, so the period-t Lagrange multipliers can be viewed as a function λₜ(ηₜ) of this world-state history.

In accordance with an embodiment of the disclosure, the Lagrange multipliers λ are restricted to a set Λ with a simpler form, for example, constant functions or linear functions of demand. Although it may be assumed that world-state process is Markovian, the Lagrange multiplier processes need not be. For example, an optimal Lagrange multiplier (or price for power) in a world-state with medium demand may be higher if the preceding demands were low than they would be if the preceding demand states were high, reflecting the need to induce units s to start or shut down to meet the current energy demand.

Taking the terminal value to be Lₜ^{λ}(x, ηₜ)=0, the Lagrangian system DP can be written:

$$\\ \begin{matrix}{L}_{t}^{λ} ( x , {η}_{t} ) = {max}_{a ∈ A ( x , {ψ}_{t} )} {λ}_{t} ( {η}_{t} ) ( p ( a ) - {d}_{t} ) - c ( x , a , {ψ}_{t} ) + 𝔼 [ {L}_{t + 1}^{λ} ( {X}_{t} ( x , a , {ψ}_{t} ) , ( {η}_{t} , {\tilde{ψ}}_{t + 1} ) ) \vert {ψ}_{t} ] . & Equation 2\end{matrix}$$

In this embodiment, the dependence of the Lagrangian value functions on the world-state history ηₜ rather than the current world-state ψₜ (as in equation 1) reflects the most general form of Lagrange multipliers.

As can be appreciated, this Lagrangian has some nice properties and can be decomposed into unit-specific value functions, as will be described in further detail hereinbelow. In one non-limiting embodiment, the following results are standard in the loosely-coupled DP literature, although in the earlier work, the Lagrange multipliers are assumed to be constant in each period rather than arbitrary functions of the history of world-states.

In an embodiment, the properties of the Lagrangian Value Function (LVF) are relaxed, where for any λ, and η₁=(ψ₁) and x, in part (a) the decomposition can be written:

$$\\ \begin{matrix}{L}_{1}^{λ} ( x , {η}_{1} ) = {\sum }_{t = 1}^{T} 𝔼 [ {λ}_{t} ( {\tilde{η}}_{t} ) {d}_{t} ( {\tilde{ψ}}_{t} ) ] + {\sum }_{s = 1}^{S} {V}_{s , 1}^{{}_{} λ} ( {x}_{s} , {η}_{1} ) & Equation 3\end{matrix}$$

where the unit-specific value functions V_{s,1}^{λ}(xₛ,η₁) are given by the DP recursion:

$$\\ \begin{matrix}{V}_{s , 1}^{{}_{} λ} ( {x}_{s} , {η}_{1} ) = {max}_{{a}_{s} ∈ {A}_{s} ( {x}_{s} , {ψ}_{t} )} {λ}_{t} ( {η}_{t} ) {p}_{s} ( {a}_{s} ) - {c}_{s} ( {x}_{s} , {a}_{s} , {ψ}_{t} ) + 𝔼 [ {V}_{s , t + 1}^{{}_{} λ} ( {X}_{s , t} ( {x}_{s} , {a}_{s} , {ψ}_{t} ) , ( {η}_{t} , {\tilde{ψ}}_{t + 1} ) ) \vert {ψ}_{t} ] & Equation 4\end{matrix}$$

with terminal case V_{s,T+1}^{λ}(xₛ,η_{T+1})=0.

The upper bound can be written as V₁*(x, ψ₁)≤L₁^{λ}(x, η₁). And for the convexity, V_{s,1}^{λ}(xₛ, η₁) and L₁^{λ}(x, η₁) are piecewise linear and convex in λ.

As can be appreciated, the decomposition result for this embodiment follows from rearranging terms in equation 2. In this manner, the fact that the Lagrangian DP decomposes in this way means the difficulty of evaluating the system Lagrangian of equation 3 is determined by the complexity of the unit-specific DPs in equation 4. Intuitively, in these unit-specific DPs, the units s are paid a price λₜ per unit of power produced in period t, and each unit s is managed to maximize its own expected reward. As will be described in further detail hereinbelow, these unit-specific DPs may have properties that may simplify their solution.

In embodiments, the upper bound follows because in the Lagrangian DP, equation 2 is a relaxation of the original DP of equation 1. For example, in equation 2 the DM may choose actions that are feasible and optimal for equation 1 and earn the same value for equation 1 but may also choose actions that do not match demand and possibly earn more. In this manner, the Lagrangian value function provides an upper bound on the primal DP of equation 1. As can be appreciated, it is desirable to find the best or optimal such bound. Given a set of feasible Lagrange multipliers Λ and an initial state (x, ψ), a constrained Lagrangian dual problem can be considered:

$$\\ \begin{matrix}{min}_{λ ∈ {}_{} Λ} {}_{} {L}_{1}^{λ} ( x , {η}_{1} ) . & Equation 5\end{matrix}$$

In embodiments, if the set of allowed Lagrange multiplier functions A is convex, the convexity indicates that this Lagrangian dual problem is a convex optimization problem.

The Lagrangian dual problem of equation 5 may be understood in more detail when considering the gradient structure of L₁^{λ}(x, η₁). In this manner, the initial state (x, η₁) may be fixed and in embodiments, L(λ)=L₁^{λ}(x, η₁) and Vₛ(λ)=V_{s,1}^{λ}(xₛ, η₁). It is envisioned that αₛ may denote an [symbol] -adapted policy for managing unit s that selects actions in each period that are feasible (in Aₛ(xₛ, ψₜ)) for the resulting sequence of plant states and the exogenous sequence of world-states; where Aₛ may denote the set of all such feasible policies for unit s. In embodiments, c_{s,t}(αₛ, ηₜ) and p_{s,t}(αₛ, ηₜ) may denote the period-t cost and energy production at unit s given policy αₛ and world-state history ηₜ. With this notation, the unit-specific DP of equation for may be written as a maximization of the total reward over unit-specific policies αₛ:

$$\\ \begin{matrix}{V}_{s} ( λ , {α}_{s} ) = {\sum }_{t = 1}^{T} 𝔼 [ {λ}_{t} ( {\tilde{η}}_{t} ) {p}_{s , t} ( {α}_{s} , {\tilde{η}}_{t} ) - {c}_{s , t} ( {α}_{s} , {\tilde{η}}_{t} ) ] , & Equation 6\end{matrix}$$

$$\\ {V}_{s} ( λ ) = {max}_{{α}_{s} ϵ {}_{} {A}_{s}} {V}_{s} ( λ , {α}_{s} )$$

In embodiments, the gradients of the unit-specific DPs and Lagrangian can be characterized by viewing the Lagrange multiplier process λ=(λ₁(η₁, . . . , λ_{T}(η_{T})) as a vector (λ₁(η_{1,1}), . . . , λ₁(η_{1,η}_{₁}), . . . , λ_{T}(η_{T,1}), . . . , η_{T}(η_{T,η}_{₁})) where n_{t,1}, . . . , η_{t,η}_{ₜ} denotes the possible world-state histories in period t and ηₜ=|Ψ|^{t}. The set of feasible Lagrange multiplier processes Λ may then be viewed as a subset of [symbol] ^{N} where N=Σₜ₌₁^{T} ηₜ). It is envisioned that if the evolution of world-states is viewed as a (non-recombining) scenario tree, Nis the total number of nodes in the tree. In this manner, if π(η_{t,i}) denotes the probability of world-state history η_{t,i} occurring and

d_{π}=(π(η_{1,1})d₁(η_{1,1}), . . . ,π(η_{1,η}_{₁})d₁(η_{1,η}_{₁}), . . . ,π(η_{T,1})d_{T}(η_{T,1}), . . . ,π(η_{T,η}_{_{T}})d_{T}(η_{T,η}_{_{T}}))

denotes the probability-weighted demand realizations corresponding to these periods and world-state histories.

In accordance with another embodiment of the disclosure, the gradients of the Lagrangian are relaxed, where Aₛ*(λ) denotes the set of optimal policies for unit s given Lagrange multiplier process λ. In this manner, subgradients for the unit-specific problems are written, for any αₛ∈Aₛ*(λ):

$$\\ \begin{matrix}{∇}_{s} ( {α}_{s} ) = ( π ( {η}_{1 , 1} ) {p}_{s , 1} ( {α}_{s} , {η}_{1 , {η}_{1}} ) , … , π ( {η}_{1 , {η}_{1}} ) {p}_{s , 1} ( {α}_{s} , {η}_{1 , {η}_{1}} ) , … , π ( {η}_{T , 1} ) {p}_{s , T} ( {α}_{s} , {η}_{T , 1} ) , … , π ( {η}_{T , {η}_{T}} ) {p}_{s , T} ( {α}_{s} , {η}_{T , {η}_{T}} ) ) & Equation 7\end{matrix}$$

is a subgradient of Vₛ at λ; that is Vₛ(λ′)≥Vₛ(λ)+∇ₛ(αₛ)^{T}(λ′−λ) for all λ′. The subdifferential (the set of all subgradients) of Vₛ at λ is ∂Vₛ(λ)=conv{∇ₛ(αₛ):αₛ∈Aₛ(λ)} where convA denotes the convex hull of the set A.

Subgradients for the Lagrangian can be determined, where in embodiments, the subdifferential of L at λ is:

$$\\ \begin{matrix}\partial L ( λ ) = - {d}_{π} + {\sum }_{s = 1}^{S} \partial {V}_{s} ( λ ) & Equation 8\end{matrix}$$

$$\\ \begin{matrix}- {d}_{π} + conv {}_{} \{ {\sum }_{s = 1}^{S} {∇}_{s} ( {α}_{s} ) : {α}_{s} ∈ {A}_{s}^{*} ( λ ) ∀ s \} & Equation 9\end{matrix}$$

where the sums are setwise (e.g., Minkowski) sums.

As can be appreciated, the subgradients for the unit-specific problems follows from Danskin's Theorem and the representation of equation 7. The subgradients for the Lagrangian then follows from standard results in convex analysis. As can be appreciated, these are standard results in the loosely coupled DP literature, adapted here to the general form of [symbol] -adapted Lagrange multipliers.

In one non-limiting embodiment, in a first theorem, the optimality conditions for the Lagrangian dual problem of equation 5 can be theorized supposing λ is a convex set of feasible Lagrange multiplier processes. In this manner, for an abstract form, λ*∈Λ is an optimal solution for the Lagrangian dual problem of equation 5 if and only if:

$$\\ \begin{matrix}O ∈ \partial L ( {λ}^{*} ) + ( {λ}^{*} ) & Equation 10\end{matrix}$$

where [symbol] (λ*) is the normal cone of λ at λ*. Given the (assumed) convexity of A, [symbol] (λ*) is the set of all z∈ [symbol] ^{N} such that z^{T}(λ−λ*)≤0 for all λ∈Λ.

For a mixture form, A_{S}*(λ) may denote the set of optimal policies for unit s given Lagrange multiplier process λ. Then λ* is an optimal solution for the Lagrangian dual problem of equation 5 if and only if, for each s there is a set of policies {α_{s,i}}ᵢ₌₁^{m}^{ₛ} with α_{s,i}∈Aₛ*(λ*) and mixing weights {γ_{s,i}}ᵢ₌₁^{m}^{ₛ} (γ_{s,i}>0 and Σᵢ₌₁^{mis s} γ_{s,i}=1) such that:

$$\\ \begin{matrix}{d}_{π} - {\sum }_{S = 1}^{S} {\sum }_{i = 1}^{{m}_{s}} {γ}_{s , i} {∇}_{s} ( {α}_{s , i} ) ∈ ( {λ}^{*} ) & Equation 11\end{matrix}$$

where ∇ₛ(α_{s,i}) is the probability-weighted time-and-state contingent production vector for policy α_{s,i} for unit s, given as the gradient of equation 7.

For linear price functions, in embodiments, A may be contained in a K-dimensional linear subspace of [symbol] ^{N} with:

$$\\ \begin{matrix}{λ}_{t} ( {η}_{t} ) = {β}_{1} {b}_{1 , t} ( {η}_{t} ) + … + \vert {β}_{K} {b}_{K , 1} ( {η}_{t} ) . & Equation 12\end{matrix}$$

e.g., a linear combination of some set of “basis functions” β_{k,t}(ηₜ). Then λ* is an optimal solution for the Lagrangian dual problem if and only if, for each s, there is a set of optimal set of policies {α_{s,i}}ᵢ₌₁^{m}^{ₛ} with α_{s,i}∈Aₛ*(λ*) and mixing weights {γ_{s,i}}ᵢ₌₁^{m}^{ₛ}, such that, for all k,

$$\\ \begin{matrix}{\sum }_{s = 1}^{S} {\sum }_{i = 1}^{{m}_{s}} {γ}_{s , i} {\sum }_{t = 1}^{T} 𝔼 {}_{} [ {b}_{k , t} ( {\tilde{η}}_{t} ) {p}_{s , t} ( {α}_{s , t} , {\tilde{η}}_{t} ) ] = {\sum }_{t = 1}^{T} 𝔼 {}_{} [ {b}_{k , t} ( {\tilde{η}}_{t} ) {d}_{t} ( {\tilde{η}}_{t} ) ] & Equation 13\end{matrix}$$

with Σₛ₌₁^{S} mₛ≤S+K; thus, no more than K units will have mixed policies.

As can be appreciated, the first result here is a standard result for convex optimization. The mixture form then follows from equations 9 and 10 using, in one non-limiting embodiment, Caratheodory's representation of the convex set in equation 9. In embodiments, ∇ₛ(α_{s,i}) may be the probability-weighted production vector given policy α_{s,i} (optimal for λ*), the left side of equation 11 may be interpreted as the (probability-weighted) residual or optimally “fitting” the Lagrangian production model to the observed demands d_{π}: the optimality condition of equation 11 requires this residual to lie in the normal cone [symbol] (λ*) of the constraint set A. The refinement of the linear price functions follows from the mixture form and standard results about the form of basic feasible solutions for linear systems of equations.

With price models of the form of equation 12, calculations may be done in a K-dimensional subspace of Λ and the results hereinabove imply the Lagrangian dual problem has a particularly nice structure. In embodiments, a Lagrangian dual problem with linear prices may be used, which in embodiments, supposes that the price model λ(β) may have the form of equation 12 with weight vectors β∈ [symbol] ^{K}. In this manner, the Lagrangian dual problem of equation 5 may be written as:

[symbol]

$$\\ \begin{matrix}{min}_{β} {}_{} {L}_{1}^{λ ( β )} ( x , {η}_{1} ) , & Equation 14\end{matrix}$$

where (a) the objective L₁^{λ(β)} is piecewise linear and convex in β, and (b) for any policy αₛ that is optimal for the unit-specific DP of equation 4 with prices λ(β), ∇(α)=(∇₁, . . . , ∇_{K}), where:

$$\\ \begin{matrix}{∇}_{k} = - {\sum }_{t = 1}^{T} 𝔼 {}_{} [ {b}_{k , t} ( {\tilde{η}}_{t} ) {d}_{t} ( {\tilde{η}}_{t} ) ] + {\sum }_{s = 1}^{S} {\sum }_{t = 1}^{T} 𝔼 {}_{} [ {b}_{k , t} ( {\tilde{η}}_{t} ) {p}_{s , t} ( {α}_{s}^{{}_{} λ ( β )} , {\tilde{η}}_{t} ) ] & Equation 15\end{matrix}$$

is a subgradient of L₁^{λ(β)} at β.

As can be appreciated, given this piecewise-linear convex structure, it is natural to use cutting-plane methods to solve equation 14 as, in this setting, the cutting plane algorithm is guaranteed to converge to an optimal X in a finite number of iterations. The objective and gradient calculations both decompose across units and the unit-specific gradient terms (inside the sum over s in equation 15) are straightforward to calculate when solving the unit-specific DPs in equation 4. As can be appreciated, this implies that the values and gradients may be evaluated in parallel within the cutting plane routine, which may be convenient for large systems (e.g., a large S).

In embodiments, no constraints may be on the form of the price process other than it is [symbol] -adapted. In this manner, Λ= [symbol] ^{N} where as noted hereinabove, N=Σₜ₌₁^{T}ηₜ is the total number of world-state histories over time. In embodiments, [symbol] (λ*) includes only the zero vector and equation 11 means that the optimal Lagrange multiplier process λ* leads to a mixture of policies that exactly matches the realized demand in every possible world-state in every period. These mixed policies “convexify” the underlying objective function, and thus L(λ*) need not provide a tight bound on the optimal value with a feasible policy (e.g., there may be a duality gap).

In a second theorem, it is envisioned that an unconstrained duality gap may be theorized by supposing the production possibilities are convex for all units and unit costs and production are bounded. In this manner, for any x and η₁(=ψ₁), and optimal Lagrange multiplier process λ* for the Lagrangian dual problem of equation 5 with Λ= [symbol] ^{N}, there is L₁^{λ*}(x,η₁)−V₁*(x,ψ₁)≤k, where, for a fixed time horizon, k is independent of both N and S.

In one non-limiting embodiment, assuming optimal costs grow linearly in the number S of units, the above-described theorem implies that the relative duality gap for the unconstrainted price model converges to zero at rate 1/S as the number of units S grows large. In this manner, it would be expected for these duality gaps to be relatively small for large systems. As can be appreciated, the key insight underlying this result is that, with a single demand-matching constraint for each period and state, the optimal Lagrangian policy will mix policies for a single unit is each period and/or state. It is envisioned that different units may mix in different periods and states and the bound may be given by considering the largest potential gap across the S units. As can be appreciated, the assumption of the above-described theorem that units' production possibilities are convex is required to evaluate unit costs for “mixed” actions. Through this condition is satisfied for storage units 14, generation nits 12 may have non-convex production possibilities. For example, using a notation described in further detail hereinbelow, the possible production levels for a generation unit may be {0}∪[pₛ, p̅ₛ], where 0 corresponds to an “off” state with zero production and p̅ₛ≥pₛ>0. Thus, one cannot achieve production levels between 0 and pₛ. However, in embodiments, these production possibility sets may be convexified by augmenting generation units 12 to allow them to shed production, albeit at some cost: one can achieve levels between 0 and pₛ by producing at pₛ and shedding the excess production. As can be appreciated, though solving the unconstrained Lagrangian dual may be difficult when the number of world-state histories is large, the above-described theorem suggests that, in large systems with complex uncertainties, little is lost in working with the Lagrangian relaxation and, with judiciously chosen price models, the LR relaxation of equation 2 can provide a good approximation of the original value function of equation 1.

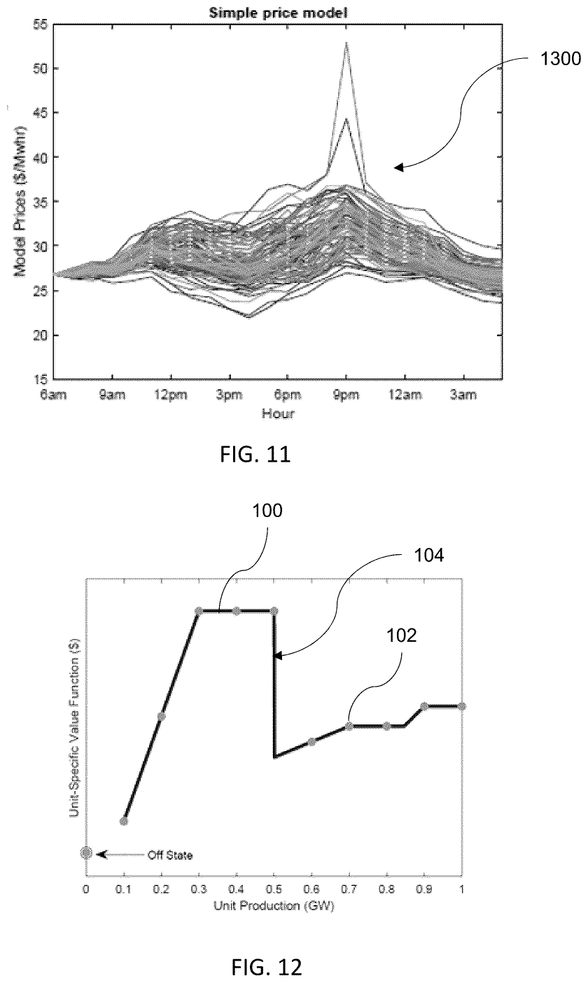

With reference to FIG. 11, in accordance with another embodiment of the disclosure, A may consist of Lagrange multipliers that are constant in each period, which may be represented in the form of equation 12 by considering T basis functions b_{k,t}(ηₜ) for k=t and all ηₜ, and zero otherwise. The optimality condition of equation 13 becomes:

$$\\ \begin{matrix}{\sum }_{s = 1}^{S} {\sum }_{i = 1}^{{m}_{s}} {γ}_{s , i} {}_{} 𝔼 {}_{} [ {p}_{s , i} ( {α}_{s} , {\tilde{η}}_{t} ) ] = 𝔼 {}_{} [ {d}_{t} ( {\tilde{η}}_{t} ) ] for all t , & Equation 16\end{matrix}$$

where the γ_{s,i} are mixing weights in the first theorem described hereinabove (e.g., linear price functions). This price model utilizes period-specific constants, which may result in the plot 1100 of model prices ($/Mwhr) over the period of time illustrated in FIG. 11. In embodiments, these conditions can be interpreted as saying that the optimal Lagrange multipliers (prices) are such that total production in the Lagrangian matches demand “in expectation” in each period, where the expectation includes the mixing of policies as well as uncertainty about demand. Note that these prices are deterministic and reflect time-of-day effects but are not sensitive to changing demand or world-states. As will be described in further detail hereinbelow, this deterministic price model may not perform well in numerical experiments.

In embodiments, period-linear prices may be considered, which may result in the plot 1200 of model prices ($/Mwhr) over the period of time illustrated in FIG. 12. It is envisioned that A may consist of Lagrange multipliers in each period that are affine functions of demand in that period: λₜ(ηₜ)=β_{t,0}+β_{t,1}dₜ(ηₜ). This model may be represented in the form of equation 12 using 2T basis functions. The first T basis functions are constants β_{k,t}(ηₜ)=1 for k=t for all ηₜ and 0 otherwise, as described hereinabove; the corresponding βₖ represent period-specific intercept terms. The next T basis functions are the period-t demands, β_{k,t}(ηₜ)=dₜ(ηₜ) for k=T+t, and zero otherwise; the corresponding βₖ represent period-specific slope terms. The optimality conditions of equation 13 then require that production in the Lagrangian matches demand in expectation in each period, as in equation 16 described hereinabove, and

$$\\ \begin{matrix}{\sum }_{s = 1}^{S} {\sum }_{i = 1}^{{m}_{s}} {γ}_{s , i} {}_{} 𝔼 {}_{} [ {p}_{s , i} ( {α}_{s} , {\tilde{η}}_{t} ) {d}_{t} ( {\tilde{η}}_{t} ) ] = 𝔼 {}_{} [ {{d}_{t} ( {\tilde{η}}_{t} )}^{2} ] for all t . & Equation 17\end{matrix}$$

As can be appreciated, equations, or conditions, 16 and 17 imply that, with optimal weights (bₜ in equation 12), the simple linear regression of total production in period t in the Lagrangian model regressed on demand in period t would have unit slope and zero intercept, in each period. This price model is stochastic, captures time-of-day effects, and has time-of-day-specific demand effects. It is envisioned that any number of price models are possible without departing from the scope of the disclosure. Other basis functions may be added to the Lagrange multiplier model. In one non-limiting embodiment, a model may include lagged demand as well as the current demand in the Lagrangian model to reflect the need to induce units that were previously off to start or units that were on to shut down to meet the current demand. As can be appreciated, it is desirable to choose a functional form for the price model with computational considerations in mind so the Lagrangian dual problem of equation 5 can be solved within a reasonable time. In this manner, it is desirable to have (i) relatively few parameters to be optimized, (ii) gradients that are “easy” to calculate, and (iii) small world states and limited dependence on the history of world-states, so the state spaces in the unit-specific DPs are not too large. As can be appreciated, with many periods and significant uncertainty, the number of parameters (N) in the unconstrained case will likely be prohibitively large.

In embodiments, the process may proceed incrementally, starting with a simple model and then complicating as necessary. In one non-limiting embodiment, good results are obtained using models that are quite simple, such as for example, the simple price model that may result in a plot 1300 of model prices ($/Mwhr) over the period of time illustrated in FIG. 10. For example, there is no apriori reason that period-specific constants or linear terms be used in the price model. For example, in any period, prices may be assumed to be a linear function of demand in that period, with the same slope and intercept in every period; this would correspond to a price model with just two parameters. As can be appreciated, choosing the form of the price model (e.g., choosing basis functions) is something of an art and, at a high level, similar to choosing basis functions for a regression model or other approximate DP methods.

As described hereinabove, the energy system 10 includes generation units 12 and storage units 14, which can be identified by s. Each unit s includes a state space Xₛ, possible actions Aₛ(xₛ,ψₜ), costs c₃(xₛ,aₛ,ψₜ), and production pₛ(aₛ) levels, where these functions may depend on the current unit state xₛ, action aₛ, and world state ψₜ.

As described hereinabove, the broad category of generation units 12 may include nuclear plants, thermal generation plants, peaking plants, etc., with parameters and constraints varying by unit. For example, nuclear plants may have large startup and shutdown costs and low variable costs. Peaking plants (e.g., natural gas turbines) may have low startup and shutdown costs but may have relatively high operating costs. Thermal plants may be between these two cases, having significant startup costs and ramping constraints but potentially having lower operating costs.

In embodiments, a generation unit 12 may be in an “off” state, denoted by the number 0, or an “on” state producing at some production level p between the lower bound pₛ>0 and the upper bound p̅ₛ; resulting in a state space Xₛ of {0}∪[pₛ, p̅ₛ]. The action space Aₛ may represent the next-period state (off or producing); thus Aₛ=Xₛ and x_{s,t}(xₛ, aₛ, ψₜ)=aₛ. In embodiments, production may ramp up or down in a given period by at most r_{s,u} and r_{s,d} (respectively); the maximum production achievable at startup is p_{s,u}; and the maximum production rate where shutdown is possible is p_{s,d}. Therefore, the set of feasible actions for a generation unit s may be:

$$\\ {A}_{s} ( {x}_{s} , {ψ}_{t} ) = \{ \begin{matrix}\{ 0 \} ⋃ [ \underline{p} {}_{s} , {p}_{s , u} ] & if {x}_{s} = 0 , \\ \{ 0 \} ⋃ ( [ \underline{p} {}_{s} , {\overline{p}}_{s} ] ⋂ [ {x}_{s} - {r}_{s , d} , {x}_{s} + {r}_{s , u} ] ) & if {x}_{s} \neq 0 and {x}_{s} \leq {p}_{s , d} , \\ [ \underline{p} {}_{s} , {\overline{p}}_{s} ] ⋂ [ {x}_{s} - {r}_{s , d} , {x}_{s} + {r}_{s , u} ] & otherwise .\end{matrix}$$

The production for generation unit s is pₛ(aₛ)=aₛ. As can be appreciated, if there are minimum downtime constraints requiring a unit s to be off for at least l periods when shut down, the unit state space may be augmented to indicate how long a unit has been off. In embodiments, the t+1 time index in the continuation value when shutting down in equation 4 may be replaced with t+1 so the unit is not available to be started up again until period t+l. It is envisioned that minimum uptime constraints can be handled similarly.

As can be appreciated, the production costs include fixed costs c_{s,n} (e.g., no-load costs), as well as startup costs c_{s,u} and shutdown costs c_{s,d}. In embodiments, the cost function may be written as

$$\\ {c}_{s} ( {x}_{s} , {a}_{s} , {ψ}_{t} ) = \{ \begin{matrix}0 & if {x}_{s} = 0 and {a}_{s} = 0 , \\ {c}_{s , u} + {c}_{s , n} + {c}_{s , f} {a}_{s} & if {x}_{s} = 0 and {a}_{s} \neq 0 , \\ {c}_{s , d} & if {x}_{s} \neq 0 and {a}_{s} = 0 , \\ {c}_{s , n} + {c}_{s , f} {a}_{s} & otherwise .\end{matrix}$$

As can be appreciated, in principle, there may be world-state dependent variable costs c_{s,f} (or other costs) representing uncertainty in fuel costs. In one non-limiting embodiment, fuel costs are assumed to be constant.

Although the state and action spaces described hereinabove include a continuum of possible production levels, in the context of the unit-specific DPs for the Lagrangian, it is envisioned that the production levels may be restricted to a finite set of production levels that are potentially optimal. As can be appreciated, this restriction generalizes the idea of a “bang-bang” solution: if there is no ramping constraints or startup or shutdown limits or costs, it would be optimal for a plant to be producing at either its upper limit or at zero, according to whether the operating profit, p̅ₛ(λₜ(ηₜ)−c_{s,f})−c_{s,n}, is positive or negative for a given world-state. With ramping constraints or startup and solution constraints and costs, the DM may need to consider the effects of current actions on future feasible sets of actions.

As can be appreciated, this logic suggests that there may be a discrete set of production levels that an optimal policy would visit. These “grid” values may be:

$$\\ \begin{matrix}{}_{s} = \{ \hat{x} + {ir}_{s , u} - {jr}_{s , d} : i , j ∈ \{ {p}_{s , 1} , \underline{p} {}_{s} , {\overline{p}}_{s} , {p}_{s , u} , {p}_{s , d} \} \} ⋂ [ \underline{p} {}_{s} , {\overline{p}}_{s} ] . & Equation 18\end{matrix}$$

In embodiments, these are the feasible values (between pₛ and p̅ₛ) that can be reached by ramping up or down as much as possible (r_{s,u} and r_{s,d}) repeatedly over time, starting from the unit's initial production level (p_{s,1} if not off initially), the minimum or maximum levels pₛ and p̅ₛ, the maximum startup level p_{s,u}, or the maximum shutdown level p_{s,d}. In one non-limiting embodiment, one of the generation units 12 may have pₛ=310, p̅ₛ=844, p_{s,u}=p_{s,d}=310, and ramp limits r_{s,u}=r_{s,d}=180. If the unit starts in the off state, the grid values may be {310, 490, 670, 844, 664, 484}. The result described hereinbelow indicates that rather than considering a continuum of possible states in the unit-specific DP, focus can be made on a state space consisting of these six production levels plus the off-state.

In embodiments, the properties of generation units 12 can be determined and/or considered, where any λ∈Λ, with [symbol] ₛ denoting the set of gird points defined in equation 18 for generation unit s. For every t and ηₜ, the following hold:
(a) Without shutdown decisions (e.g., if c_{s,d}=∞), V_{s,t}^{λ}(x, ηₜ) is piecewise linear and concave on x∈[pₛ, p̅ₛ] with breakpoints in [symbol] ₛ.
(b) With shutdown decisions, V_{s,t}^{λ}(x, ηₜ) is convex in x between grid points, e.g., suppose g₁ and g₂ are adjacent points in [symbol] ₛ, μ∈[0,1], and x₁, x₂, and x_{μ} are such that x_{μ}=μx₁+(1−μ)x₂ and g₁≤x₁≤x_{μ}≤x₂≤g₂. Then, V_{s,t}^{λ}(x_{μ}, ηₜ)≤μV_{s,t}^{λ}(x₁, ηₜ)+(1−μ)V_{s,t}^{λ}(x₂, ηₜ).
   As can be appreciated, in both cases, if x is in [symbol] ₛ, and it is optimal to produce, then there exist optimal production levels in [symbol] ₛ in period t and thereafter.

The result of part (a) generalizes the bang-bang logic to incorporate ramping limits and may be proven by backward induction: a DM facing a piecewise linear convex continuation value with rewards that are linear in the production level will either want to ramp up or down as much as possible (which, if starting at a grid point, would be a grid point) or else operate at a breakpoint of the continuation value (which, by the induction hypothesis, is also a grid point). As can be appreciated, though it is not surprising that including shutdown decisions would destroy the concavity of value function, it is perhaps surprising that local convexity emerges. This local convexity is enough to ensure the desired result: with rewards that are linear in the production level, producing at any point between grid points is dominated by producing at one of the bracketing grid points. In this manner, these sets of grid points may be quite small. For example, when modeling an energy system 10 having 129 generation units 12, the number of grid points may range from 1 (e.g., when pₛ=p̅ₛ) to 10, with an average of 2.60. As can be appreciated, this model assumes that the costs when producing are linear in the production level. In practice, however, it is sometimes assumed that these costs are piecewise linear in production. The result of the above-described embodiment also holds with piecewise linear convex costs provided the set of grid points is augmented to include the breakpoints of the piecewise linear cost function in the set of possible values \hat{x} in equation 18 to generate the grid. It is envisioned that convexity of the piecewise linear costs functions may only be needed for the concavity claim in part (a) of the above-described embodiment.

With reference to FIG. 12, a value function 100 for a generation unit with shutdown decisions is illustrated in accordance with the above-described embodiment. It is envisioned that for this unit, pₛ=0.1, p̅ₛ=1.0, and r_{s,u}=r_{s,d}=0.1, p_{s,u}=0.2, and p_{s,d}=0.3. In one non-limiting embodiment, grid points 102 of the value function 100 lie at increments of 0.1. The convexity of the value function 100 between grid points 102 is evident in several places. In an embodiment using a 24-period deterministic example, prices are randomly generated to create an “interesting” value function 100. In this manner, a low price is expected in two periods: the sharp drop 104 in the value function 100 at 0.5 GW reflects the fact that, for production states above this level, it is not possible to ramp down enough (e.g., to p_{s,d}=0.3 or less) to shut the unit down before the low-price period.

In embodiments, to ensure the primal problem of equation 1 is feasible, it may be assumed that there exist two artificial units for shedding demand or supply. The units may have positive fuel costs c_{s,f} for shedding demand and negative cists for shedding supply, denoted c_{d-shed} and c_{s-shed}. In embodiments, the positive fuel costs c_{s,f} may be large. There are no startup or shutdown costs or ramping limits associated with these shedding units. The optimal policy for the supply shedding unit calls for “producing” pₛ (e.g., a large negative value) whenever λₜ(ηₜ)≤−c_{s-shed} and zero (e.g., =p̅ₛ) otherwise. In embodiments, the demand shedding unit produces p̅ₛ (e.g., a large positive value) when λₜ(ηₜ)≥c_{d-shed} and zero (e.g., =pₛ) otherwise.

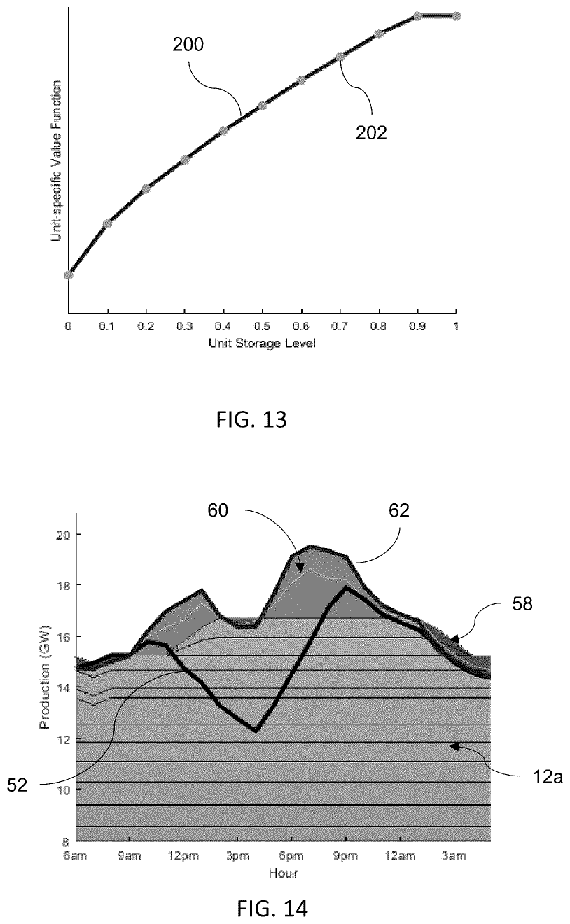

Turning to FIG. 13, it is envisioned that the state x for a storage unit 14 may represent the energy storage level of the storage unit 14. In embodiments, storage must be between minimum and maximum levels xₛ and x̅ₛ and thus Xₛ=[xₛ, xₛ]. Actions as may correspond to the amount of power generated (if positive) or consumed (if negative), resulting in p(aₛ)=aₛ, where the action space Aₛ=[pₛ, p̅ₛ] corresponds to the storage unit limits on power consumption and generation. In one non-limiting embodiment, power consumption corresponds to increasing the energy storage level for potential later generation. It is envisioned that the state transition function may be

$$\\ {X}_{s , t} ( {x}_{s} , {a}_{s} , {ψ}_{t} ) = {x}_{s} - {γ}_{s}^{{}_{} -} {a}_{s}^{{}_{} -} - {γ}_{s}^{{}_{} +} {a}_{s}^{{}_{} +} ,$$

where aₛ⁺ and as correspond to the positive and negative parts of aₛ. The constants γₛ⁻ and γₛ⁺ describe the efficiency of the storage unit: every unit of power consumed by the unit increases the energy stored by γ⁻ units, and every unit of power generated requires γ⁺ units of stored energy. In one non-limiting embodiment, the action sets for storage unit s are

$$\\ {A}_{s} ( {x}_{s} , {ψ}_{t} ) = [ \underline{p} {}_{s} , {\overline{p}}_{s} ] ⋂ [ ( {x}_{s} - {\overline{x}}_{s} ) / {γ}^{{}_{} -} , ( {x}_{s} - \underline{x} {}_{{}_{} s} ) / {γ}^{{}_{} +} ] .$$

In this embodiment, there are no costs associated with storage and in the unit-specific DP the rewards are λₜ(ηₜ)aₛ reflecting the value of the power produced or consumed.

As an be appreciated, similarly to the generation units 12 without shutdown decisions, the value functions 200 for the storage units 14 can be shown to be piecewise linear concave with breakpoints and optimal production levels restricted to a finite grid that in embodiments, may be determined in advance. It is envisioned that like the generation unit case described hereinabove, these grid points 202 may be defined by ramping storage up and down by integer multiples of γₛ⁻pₛ⁻ and γₛ⁺p̅ₛ⁺, respectively, starting from the initial storage level x₁ and the maximum and minimum storage levels xₛ and x̅ₛ. In embodiments, the above-described storage model may be extended to include random or deterministic inflows or outflows representing, for example, rainfall or evaporation at a pumped-storage hydro unit or leakage at a battery unit. It is envisioned that the piecewise linear convex structure of the model would remain, but a more refined grid may be considered to incorporate possible inflows or outflows.

As described hereinabove, the decomposed policies from solving the unit-specific DPs of equation 4 in the Lagrangian decomposition may need to be coordinated to find a production plan that meets the realized actual demand in a given period. It is envisioned that these dispatch problems (e.g., forward-looking economic dispatch problems) may be solved hourly, or in embodiments, more frequently. In one non-limiting embodiment, the unit-specific value functions are used to incorporate the longer-term effects of these dispatch decisions in the ED model. It is contemplated that actions (e.g., production levels) are chosen to solve a version of the original DP of equation 1 where the next-period value function Vₜ₊₁* is replaced by the Lagrangian Lₜ₊₁^{λ}:

$$\\ \begin{matrix}{max}_{a ∈ {}_{} A ( x )} - c ( x , a , {ψ}_{t} ) + 𝔼 {}_{} [ {L}_{t + 1}^{λ} ( {x}_{t} ( x , a , {ψ}_{t} ) , ( {η}_{t} , {\tilde{ψ}}_{t + 1} ) ) \vert {ψ}_{t} ] s . t . & Equation 19\end{matrix}$$

$$\\ p ( a ) = {d}_{t} ( {ψ}_{t} )$$

Although it is envisioned that any price process X may be used in the Lₜ^{λ}(x) in this approach, optimal price processed (e.g., solve the Lagrangian dual problem of equation 5) for a given form of price model will be described hereinbelow.

As can be appreciated, the optimization problem of equation 19 may be formulated as a mixed integer linear program (MILP) in various ways. In embodiments, a “convex hull” formulation that is convenient for use with the results provided by the unit specific DPs may be considered. In this manner, decision variables [symbol] _{s,i}∈[0,1] are introduced that are weights associated with the feasible actions a_{s,i}∈Aₛ(xₛ) considered in the unit-specific DPs. It is contemplated that these actions may include the off-state (e.g., for generation units only) and the actions a_{s,i} corresponding to production levels [symbol] ₛ that are reachable from state xₛ. For initial states xₛ that are not in [symbol] ₛ, this set may be augmented to include actions xₛ+r_{s,u} (e.g., the maximum ramp up) and xₛ−r_{s,d} (e.g., the maximum ramp down). In one non-limiting embodiment, the sets of possible next-period state for storage units 14 may be similarly augmented if the initial state is not in [symbol] ₛ. In embodiments, ns may denote the number of feasible actions for unit s. The MILP is then:

$$\\ \begin{matrix}{\sum }_{s = 1}^{S} {\sum }_{i = 1}^{{n}_{s}} {}_{s , i} {}_{} ( - {c}_{s} ( {x}_{s} , {a}_{s , i} , {ψ}_{t} ) + 𝔼 {}_{} [ {V}_{s , t + 1}^{{}_{} λ} ( {X}_{s , t} ( {x}_{s} , {a}_{s , i} , {ψ}_{t} ) , ( {η}_{t} , {\tilde{ψ}}_{t + 1} ) ) ] \vert {ψ}_{t} ) s . t . & Equation 20\end{matrix}$$

$$\\ {\sum }_{s = 1}^{S} {\sum }_{i = 1}^{{n}_{s}} {}_{s , i} {p}_{s} ( {a}_{s , i} ) = {d}_{t} ( {ψ}_{t} )$$

$$\\ {\sum }_{i = 1}^{{n}_{s}} {}_{s , i} = 1 ∀ s$$

$$\\ {}_{s , i} ∈ [ 0 , 1 ] ∀ s , i$$

$$\\ {}_{s , i} ∈ \{ 0 , 1 \} ∀ s , i corresponding to off states$$

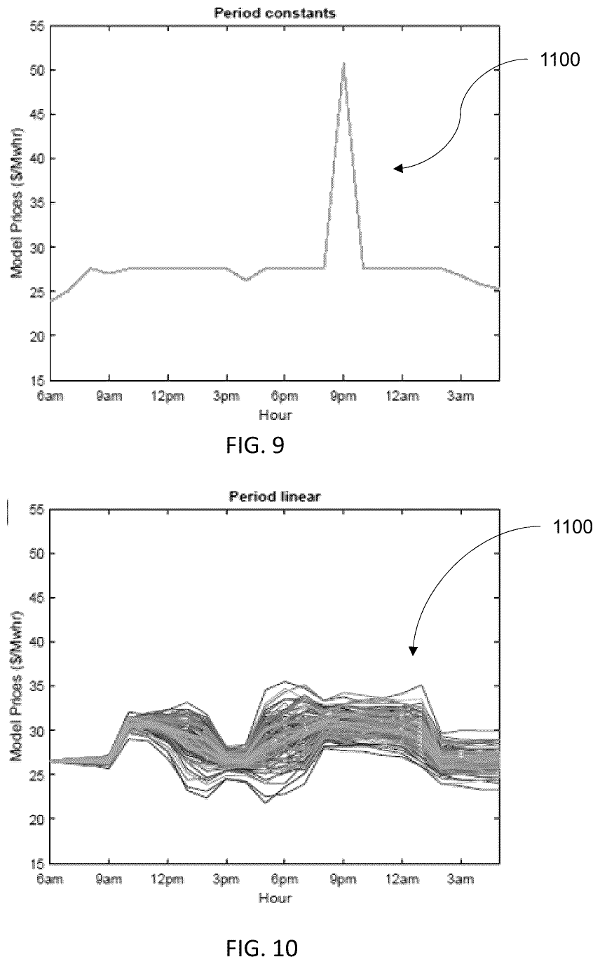

In embodiments, the expected continuation values appearing in the objective here are calculated when solving the Lagrangian dual for all actions corresponding to production levels in [symbol] ₛ, but not for those actions (e.g., corresponding to maximum ramp-up/down levels). It is envisioned that the off-grid expected continuation values may be estimated using linear interpolation. As can be appreciated, this linear interpolation is exact for storage units 14 because their value functions are piecewise linear convex with breakpoints at these grid points and is an approximation for generation units 12 because, as described hereinabove and illustrated in FIG. 9, the continuation values for generation units 12 may be strictly convex between grid points; the linear interpolation of these value functions is thus an overestimate of the actual unit-specific continuation values.

In one non-limiting embodiment, the solution to the ED problem may call for unit s to produce at the level given by Σᵢ₌₁ⁿ^{ₛ} [symbol] _{s,i}*pₛ(a_{s,i}) for the optimal weights [symbol] _{s,i}* given by equation 20. In this manner, units may operate at any level between the feasible production levels, and total production will match demand exactly. The binary constraints associated with the “off” states in equation 20 ensure that the solution cannot mix between the off-state (e.g., with zero production) and the other production levels. A simple constraint counting argument implies that, for any given setting of the binary variables, there are S+1 constraints, and therefore, at most S+1 positive weights in any basic feasible solution. Therefore, at most, one unit will be mixing among the actions considered in equation 20. Unlike the multi-period UC problem, this MILP is small. It is envisioned that there is at most one binary variable for each generation unit and the number of continuous variables is less than the sum of the grid sizes for the units. In one non-limiting embodiment, the MILP described hereinabove allows the solution to interpolate between non-adjacent grid points. It is envisioned that this formulation may be improved by introducing additional binary variables and constraints that require at most two consecutive weights to be non-zero. As can be appreciated, however, from a computational perspective this approach requires introducing an additional set of binary variables for each generation unit.

As can be appreciated, a myopic version of the ED problem may take the expected continuation values of equation 20 to be zero. It is envisioned that commitment constraints may be incorporated by requiring the binary variables for the off states for slow-start units to be either 0 or 1, according to the solution from the UC problem, and similarly constraining the weights for the storage units 14.

In one non-limiting embodiment, the ED problem assumes that the timescale matches that of the DP and its Lagrangian relaxation. It is contemplated that the time steps may be one-hour time steps, although the time steps may be more frequent (e.g., every 5 or 15 minutes) without departing from the scope of the disclosure. As can be appreciated, these problems can be solved very quickly, and as a result, the forward-looking EDs can be solved with these more refined timescales. In embodiments, if the Lagrangian DP is solved on an hourly timescale, the expected continuation values appearing in equation 18 need to be interpolated to provide expected continuation values on the more refined scale. For example, it can be assumed that the end-of-hour expected continuation values apply over the previous hour. In one non-limiting embodiment, utilizing a 5-minute timescale suggests that the dynamic approach performs well.

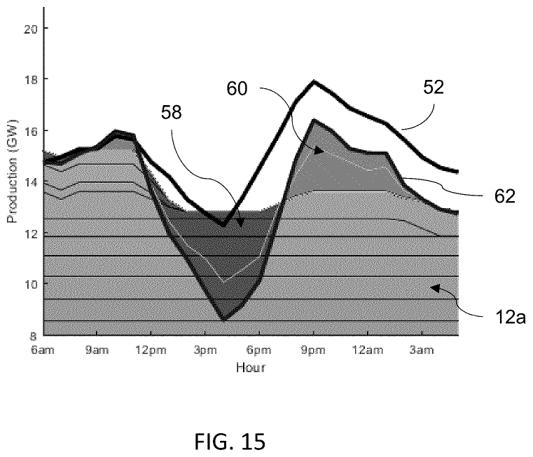

With reference to FIGS. 14 and 15, when considering uncertainty and utilizing the algorithm 44 described hereinabove and using the simple price model, the production decisions for high and low demand scenarios result in significant reductions in cost. For example, the during a high demand scenario (FIG. 14), actual demand 62 on the energy system 10 exceeds the expected demand 52 at each discrete time period. However, rather than dispatching additional generation units 12 or storage units 14 to meet the excess demand as in the myopic ED problem (FIG. 7), the forward-looking or dynamic ED meets the midday energy peaks through a combination of starting additional slow-start generation units 12a around 11 am and increased use of stored energy 60. During a low demand scenario (FIG. 8), the dynamic ED shuts down some of the operating slow start generation units 12a heading into the deeper-than-expected afternoon trough and stores more energy in the storage units 14 through this trough. As can be appreciated, by not committing generation units 12 and/or storage units 14 for the production plan, the dynamic ED enables more efficient use of available generation units 12 and/or storage units 14.

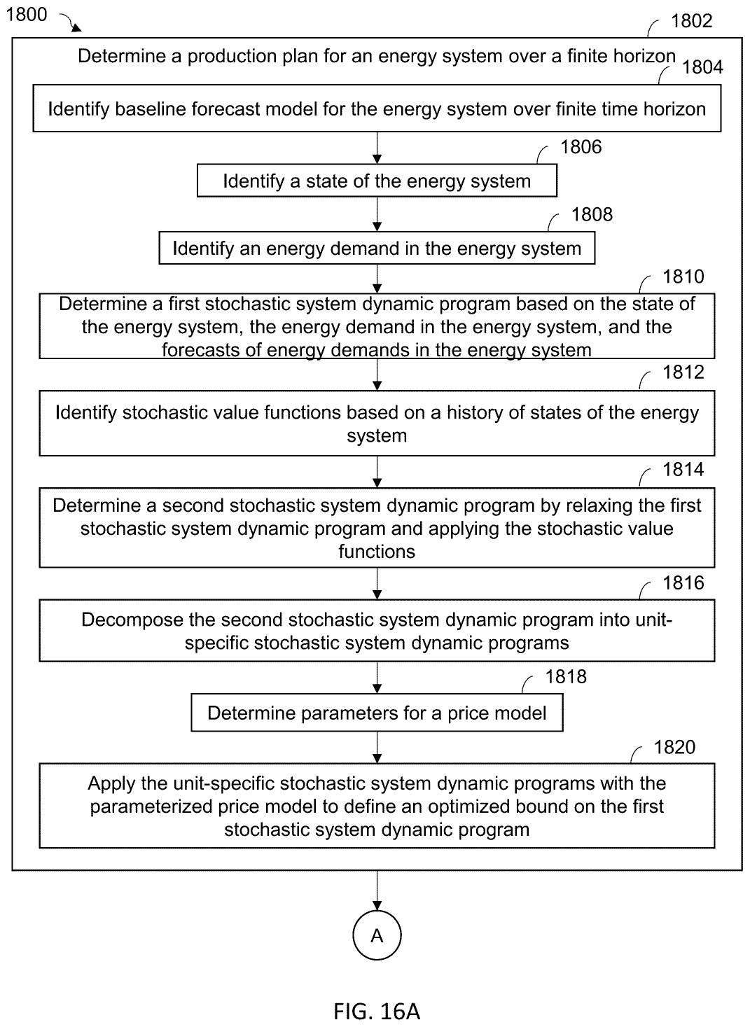

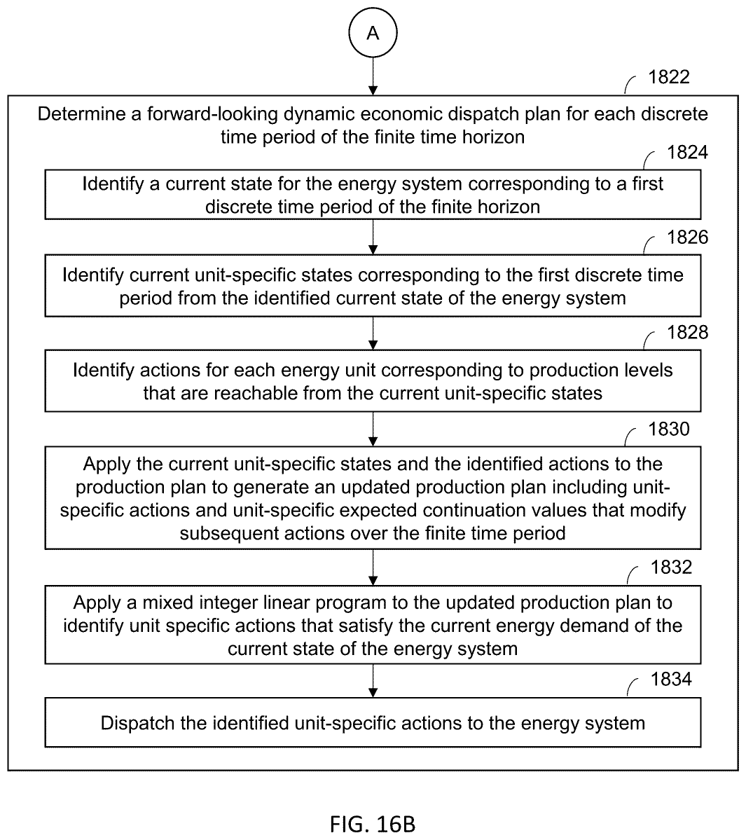

Turning to FIGS. 16A and 16B, a method of managing an energy system is described and generally identified by reference numeral 1800. The method includes determining a production plan 1802 for an energy system over a finite time horizon. In one non-limiting embodiment, determining the production plan includes identifying a baseline forecast model 1804 for the energy system over the finite time horizon, identifying a state of the energy system 1806, identifying an energy demand 1808 in the energy system, determining a first stochastic system dynamic program 1810 based on the state of the energy system, the energy demand in the energy system, and the forecasts of energy demands in the energy system, identifying stochastic value functions 1812 based on a history of states of the energy system, determining a second stochastic system dynamic program 1814 by relaxing the first stochastic system dynamic program and applying the stochastic value functions, decomposing the second stochastic system dynamic program into unit-specific stochastic system dynamic programs 1816, determining parameters for a price model 1818, and applying the unit-specific stochastic system dynamic programs with the parameterized price model to define an optimized bound 1820 on the first stochastic system dynamic program. In embodiments, the method includes determining a forward-looking dynamic economic dispatch plan 1822 for each discrete time period of the finite time horizon. It is envisioned that determining the forward-looking dynamic economic dispatch plan may include identifying a current state 1824 for the energy system corresponding to a first discrete time period of the finite horizon, identifying current unit-specific states 1826 corresponding to the first discrete time period from the identified current state of the energy system, identifying actions 1828 for each energy unit corresponding to production levels that are reachable from the current unit-specific states, applying 1830 the current unit-specific states and the identified actions to the production plan to generate an updated production plan including unit-specific actions and unit-specific expected continuation values that modify subsequent actions over the finite time period, applying 1832 a mixed integer linear program to the updated production plan to identify unit specific actions that satisfy the current energy demand of the current state of the energy system, and dispatching 1834 the identified unit-specific actions to the energy system. As can be appreciated, the above-described method may include any of the described portions of the disclosure and may be performed in any order without departing from the scope of the disclosure. It is envisioned that the method or any portion of the method may be performed as many times as necessary.

From the foregoing and with reference to the various figures, those skilled in the art will appreciate that certain modifications can be made to the disclosure without departing from the scope of the disclosure.

Although the description of computer-readable media contained herein refers to solid-state storage, it should be appreciated by those skilled in the art that computer-readable storage media can be any available media that can be accessed by the processor 30. That is, computer readable storage media may include non-transitory, volatile, and non-volatile, removable and non-removable media implemented in any method or technology for storage of information such as for example, computer-readable instructions, data structures, program modules or other data. For example, computer-readable storage media may include RAM, ROM, EPROM, EEPROM, flash memory or other solid-state memory technology, CD-ROM, DVD, Blu-Ray or other optical storage, magnetic cassettes, magnetic tape, magnetic disk storage or other magnetic storage devices, or any other medium which may be used to store the desired information, and which may be accessed by the computing system 20.

What is claimed is:

1. A method for dynamically managing an energy system, comprising:
determining a production plan for the energy system over a finite time horizon, the energy system including a plurality of energy units, wherein determining the production plan includes:
determining a first stochastic system dynamic program based on a state of the energy system and an energy demand in the energy system, the energy demand corresponding to a baseline forecast model, wherein the first stochastic system dynamic program is subject to a constraint of meeting the energy demand of the baseline forecast model over discrete time periods of the finite time horizon and a corresponding state of the energy system;
determining a second stochastic system dynamic program by relaxing the first stochastic system dynamic program, wherein relaxing the first stochastic system dynamic program includes applying stochastic value functions based on a history of states of the energy system;
decomposing the second stochastic system dynamic program into unit-specific stochastic system dynamic programs corresponding to each energy unit of the plurality of energy units; and
applying the unit-specific stochastic system dynamic programs with a price model to define a bound on the first stochastic system dynamic program, wherein the price model is based on the state of the energy system; and
determining a forward-looking dynamic economic dispatch plan using the second stochastic system dynamic program for each discrete time period of the finite time horizon, wherein determining the economic dispatch plan for each discrete time period includes:
identifying a current state for the energy system corresponding to a first discrete time period of the finite time horizon;
identifying current unit-specific states corresponding to the first discrete time period, wherein the current unit-specific states are identified from the identified current state of the energy system;
identifying actions for each energy unit corresponding to production levels that are reachable from the identified current unit-specific states;
applying the current unit-specific states and the identified actions to the production plan to generate an updated production plan, the updated production plan including unit-specific actions and unit-specific expected continuation values based on the second stochastic system dynamic system that modify subsequent actions over the finite time horizon; and
dispatching the identified unit-specific actions to the energy system.

2. The method according to claim 1, wherein identifying the current state corresponding to the first discrete time period includes identifying a current energy demand state corresponding to the first discrete time period.

3. The method according to claim 2, wherein applying the current unit-specific states includes meeting the identified current energy demand state.

4. The method according to claim 1, wherein determining the forward-looking dynamic economic dispatch plan includes applying a mixed integer linear program to the updated production plan to identify the unit specific actions that satisfy a current energy demand of the current state of the energy system.

5. The method according to claim 1, wherein determining the first stochastic system dynamic program includes determining the first stochastic system dynamic program based on the current state of the energy system, the current energy demand in the energy system, and forecasts of energy demands in the energy system.

6. The method according to claim 5, wherein determining the first stochastic system dynamic program includes subjecting the first stochastic system dynamic program to the constraints of meeting the current energy demands over the discrete time periods of the finite time horizon and the current state and the forecasted energy demands in the energy system.

7. The method according to claim 1, wherein applying the unit-specific stochastic system dynamic programs to the price model includes applying the unit-specific stochastic system dynamic programs with a parameterized price model to define a bound on the first stochastic system dynamic program.

8. The method according to claim 1, wherein determining the production plan for the energy system includes identifying price model parameters, wherein the identified price model parameters, when applied to the unit-specific stochastic system dynamic programs, define an optimized bound on the first stochastic system dynamic program.

9. A computing device for dynamically managing an energy system, comprising:
a processor; and
a memory operably coupled to the processor, the memory storing instructions, which when executed by the processor cause the processor to:
determine a production plan for an energy system over a finite time horizon, the energy system including a plurality of energy units, wherein determining the production plan includes:
determining a first stochastic system dynamic program based on a state of the energy system and an energy demand in the energy system, the energy demand corresponding to a baseline forecast model, wherein the first stochastic system dynamic program is subject to a constraint of meeting the energy demand of the baseline forecast model over discrete time periods of the finite time horizon and a corresponding state of the energy system;
determining a second stochastic system dynamic program by relaxing the first stochastic system dynamic program, wherein relaxing the first stochastic system dynamic program includes applying stochastic value functions based on a history of states of the energy system;
decomposing the second stochastic system dynamic program into unit-specific stochastic system dynamic programs corresponding to each energy unit of the plurality of energy units; and
applying the unit-specific stochastic system dynamic programs with a price model to define a bound on the first stochastic system dynamic program, wherein the price model is based on the state of the energy system; and
determine a forward-looking dynamic economic dispatch plan based on the second stochastic system dynamic program for each discrete time period of the finite time horizon, wherein determining the economic dispatch plan for each discrete time period includes:
identifying a current state for the energy system corresponding to a first discrete time period of the finite time horizon;
identifying current unit-specific states corresponding to the first discrete time period, wherein the current unit-specific states are identified from the identified current state of the energy system;
identifying actions for each energy unit corresponding to production levels that are reachable from the identified current unit-specific states;
applying the current unit-specific states and the identified actions to the production plan to generate an updated production plan, the updated production plan including unit-specific actions and unit-specific expected continuation values based on the second stochastic system dynamic program that modify subsequent actions over the finite time horizon; and
dispatching the identified unit-specific actions to the energy system.

10. The computing device according to claim 9, wherein the memory stores thereon further instructions, which when executed, cause the processor to determine the first stochastic system dynamic program based on the current energy demand state corresponding to the first discrete time period.

11. The computing device according to claim 10, wherein the memory stores thereon further instructions, which when executed, cause the processor to determine the forward looking dynamic economic dispatch plan by applying unit-specific states that meet the identified current energy demand state.

12. The computing device according to claim 9, wherein the memory stores thereon further instructions, which when executed, cause the processor to apply the unit-specific stochastic system dynamic programs with a parameterized price model to define a bound on the first stochastic system dynamic program.

13. The computing device according to claim 12, wherein the memory stores thereon further instructions, which when executed, cause the processor to identify price model parameters, wherein the identified price model parameters, when applied to the unit-specific stochastic system dynamic programs, define an optimized bound on the first stochastic system dynamic program.

14. The computing device according to claim 9, wherein the memory stores thereon further instructions, which when executed, cause the processor to determine the forward-looking dynamic economic dispatch plan by applying a mixed integer linear program to the updated production plan to identify the unit specific actions that satisfy a current energy demand of the current state of the energy system.

15. A non-transitory computer-readable storage medium storing instructions, which when executed by a processor, cause the processor to:
determine a production plan for an energy system over a finite time horizon, the energy system including a plurality of energy units, wherein determining the production plan includes:
determining a first stochastic system dynamic program based on a state of the energy system and an energy demand in the energy system, the energy demand corresponding to a baseline forecast model, wherein the first stochastic system dynamic program is subject to a constraint of meeting the energy demand of the baseline forecast model over discrete time periods of the finite time horizon and a corresponding state of the energy system;
determining a second stochastic system dynamic program by relaxing the first stochastic system dynamic program, wherein relaxing the first stochastic system dynamic program includes applying stochastic value functions based on a history of states of the energy system;
decomposing the second stochastic system dynamic program into unit-specific stochastic system dynamic programs corresponding to each energy unit of the plurality of energy units; and
applying the unit-specific stochastic system dynamic programs with a price model to define a bound on the first stochastic system dynamic program, wherein the price model is based on the state of the energy system; and
determine a forward-looking dynamic economic dispatch plan based on the second stochastic system dynamic program for each discrete time period of the finite time horizon, wherein determining the economic dispatch plan for each discrete time period includes:
identifying a current state for the energy system corresponding to a first discrete time period of the finite time horizon;
identifying current unit-specific states corresponding to the first discrete time period, wherein the current unit-specific states are identified from the identified current state of the energy system;
identifying actions for each energy unit corresponding to production levels that are reachable from the identified current unit-specific states;
applying the current unit-specific states and the identified actions to the production plan to generate an updated production plan, the updated production plan including unit-specific actions and unit-specific expected continuation values based on the second stochastic system dynamic program that modify subsequent actions over the finite time horizon; and
dispatching the identified unit-specific actions to the energy system.

16. The non-transitory computer-readable storage medium according to claim 15, wherein the instructions, when executed by the processor, further cause the energy system to apply the unit-specific stochastic system dynamic programs with a parameterized price model to define a bound on the first stochastic system dynamic program.

17. The non-transitory computer-readable storage medium according to claim 16, wherein the instructions, when executed by the processor, further cause the energy system to identify price model parameters, wherein the identified price model parameters, when applied to the unit-specific stochastic system dynamic programs, define an optimized bound on the first stochastic system dynamic program.

18. The non-transitory computer-readable storage medium according to claim 15 wherein the instructions, when executed by the processor, further cause the energy system to identify a current energy demand state corresponding to the first discrete time period.

19. The non-transitory computer-readable storage medium according to claim 18, wherein the instructions, when executed by the processor, further cause the energy system to apply the current unit-specific states to meet the identified current energy demand state.

20. The non-transitory computer-readable storage medium according to claim 15, wherein the instructions, when executed by the processor, further cause the energy system to determine the forward-looking economic dispatch plan by applying a mixed integer linear program to the updated production plan to identify the unit specific actions that satisfy a current energy demand of the current state of the energy system.
